(19) United States
(12) Patent Application Publication
(10) Pub. No.: US 2025/0328811 A1
(43) Pub. Date: Oct. 23, 2025

(54) FOUNDATION MODELS BUILT VIA A BOTTOM-UP PROCESS

(71) Applicant: GE Precision Healthcare LLC, Waukesha, WI (US)

(72) Inventors: Xiaomeng Dong, San Ramon, CA (US); Hongxu Yang, Helmond (NL); Ravi Soni, Livermore, CA (US); Gopal Biligeri Avinash, Concord, CA (US)

(21) Appl. No.: 18/640,152

(22) Filed: Apr. 19, 2024

(51) Int. Cl. G06N 20/00

(52) U.S. Cl. CPC G06N 20/00

(57) ABSTRACT

Systems or techniques that can facilitate building of foundation models via a bottom-up process are provided. For example, one or more embodiments described herein can comprise a system, which can comprise a memory that can store computer executable components. The system can also comprise a processor, operably coupled to the memory that can execute the computer executable components stored in memory. The computer executable components can comprise an access component that accesses a plurality of machine learning tasks. The computer executable components can further comprise a model component that builds, in a bottom-up manner, a foundation model by recursively consolidating subsets of the plurality of machine learning tasks into generalized representations.

### TECHNICAL FIELD

The subject disclosure relates generally to foundation models, and more specifically to building foundation models via a bottom-up process.

### BACKGROUND

Foundation models are large, pre-trained artificial intelligence (AI) models that are trained on a diverse range of tasks and datasets to provide a basis for more specialized models. Foundation models have achieved significant success in various AI applications as large general-purpose models. Foundation models are capable of performing a variety of tasks, such as understanding text, generating text, generating images, or natural language processing. Unfortunately, existing techniques for building foundation models require demand substantial amounts of data and computation resources, and do not generalize well to specialized fields, and thus cannot be easily implemented across different specialized domains without extensive retraining.

Accordingly, systems or techniques that can address one or more of these technical problems can be desirable.

### SUMMARY

The following presents a summary to provide a basic understanding of one or more embodiments. This summary is not intended to identify key or critical elements, or delineate any scope of the particular embodiments or any scope of the claims. Its sole purpose is to present concepts in a simplified form as a prelude to the more detailed description that is presented later. In one or more embodiments described herein, devices, systems, computer-implemented methods, apparatus or computer program products that facilitate building of foundation models via a bottom-up process are described.

According to one or more embodiments, a system is provided. The system can comprise a non-transitory computer-readable memory that can store computer-executable components. The system can further comprise a processor that can be operably coupled to the non-transitory computer-readable memory and that can execute the computer-executable components stored in the non-transitory computer-readable memory. In various embodiments, the computer-executable components can comprise an access component that can access a plurality of machine learning tasks. In various aspects, the computer-executable components can comprise a model component that can build, in a bottom-up manner, a foundation model by recursively consolidating subsets of the plurality of machine learning tasks into generalized representations.

According to one or more embodiments, a computer-implemented method is provided. In various embodiments, the computer-implemented method can comprise accessing, by a device operatively coupled to a processor, a plurality of machine learning tasks. In various aspects, the computer-implemented method can comprise building, by the device and in a bottom-up manner, a foundation model by recursively consolidating subsets of the plurality of machine learning tasks into generalized representations.

According to one or more embodiments, a computer program product for facilitating building of foundation models via a bottom-up process is provided. In various embodiments, the computer program product can comprise a non-transitory computer-readable memory having program instructions embodied therewith. In various aspects, the program instructions can be executable by a processor to cause the processor to access a plurality of machine learning tasks. In various instances, the program instructions can be further executable by the processor to cause the processor to build, in a bottom-up manner, a foundation model by recursively consolidating subsets of the plurality of machine learning tasks into generalized representations.

### DESCRIPTION OF THE DRAWINGS

FIG. 1 illustrates a block diagram of an example, non-limiting system that facilitates building of foundation models via a bottom-up process in accordance with one or more embodiments described herein.

FIG. 2 illustrates a block diagram of an example, non-limiting system including an assignment component and a grouping component that facilitates building of foundation models via a bottom-up process in accordance with one or more embodiments described herein.

FIG. 3 illustrates an example, non-limiting block diagram that facilitates defining of prompts for machine learning tasks in accordance with one or more embodiments described herein.

FIG. 4 illustrates an example, non-limiting diagram of orthogonal prompts for machine learning tasks in accordance with one or more embodiments described herein.

FIG. 5 illustrates an example, non-limiting block diagram of a foundation model hierarchy in accordance with one or more embodiments described herein.

FIG. 6 illustrates an example, non-limiting block diagram that facilitates building of foundation models via a bottom-up process in accordance with one or more embodiments described herein.

FIG. 7 illustrates an example, non-limiting block diagram of multi-task learning of a bottom-up foundation model in accordance with one or more embodiments described herein.

FIG. 8 illustrates an example, non-limiting block diagram that facilitates isolation of bottom-up processes in accordance with one or more embodiments described herein.

FIG. 9 illustrates an example, non-limiting system including a training component that facilitates building of foundation models via a bottom-up process in accordance with one or more embodiments described herein.

FIG. 10 illustrates an example, non-limiting block diagram that facilitates task consolidation by training of a bottom-up foundation model with machine learning task prompts in accordance with one or more embodiments described herein.

FIG. 11 illustrates an example, non-limiting block diagram of a bottom-up foundation model after training in accordance with one or more embodiments described herein.

FIG. 12 illustrates an example, non-limiting block diagram that facilitates training a bottom-up foundation model with variety robustness in accordance with one or more embodiments described herein.

FIG. 13 illustrates an example, non-limiting block diagram of task adaptation via a bottom-up built foundation model in accordance with one or more embodiments described herein.

FIG. 14 illustrates an example, non-limiting diagram of model performance for task adaptation in accordance with one or more embodiments described herein.

FIG. 15 illustrates an example, non-limiting block diagram of task adaptation via a bottom-up built foundation model in accordance with one or more embodiments described herein.

FIG. 16 illustrates an example, non-limiting diagram of model performance for task adaptation in accordance with one or more embodiments described herein.

FIG. 17 illustrates an example, non-limiting diagram of creating pre-trained weights with variety robustness for task adaptation in accordance with one or more embodiments described herein.

FIGS. 18A and 18B illustrate an example, non-limiting diagram of model performance for task adaptation with variety robustness in accordance with one or more embodiments described herein.

FIG. 19 illustrates an example, non-limiting diagram of model performance of task consolidation in accordance with one or more embodiments described herein.

FIGS. 20A and 20B illustrate an example, non-limiting diagram of model performance with orthogonal prompts in accordance with one or more embodiments described herein.

FIG. 21 illustrates an example, non-limiting diagram of model performance of emergence property in accordance with one or more embodiments described herein.

FIG. 22 illustrates a flow diagram of an example, non-limiting computer-implemented method that facilitates building of foundation models via a bottom-up process in accordance with one or more embodiments described herein.

FIG. 23 illustrates a flow diagram of an example, non-limiting computer-implemented method that facilitates building of foundation models via a bottom-up process in accordance with one or more embodiments described herein.

FIG. 24 illustrates a block diagram of an example, non-limiting operating environment in which one or more embodiments described herein can be facilitated.

FIG. 25 illustrates an example networking environment operable to execute various implementations described herein.

### DETAILED DESCRIPTION

The following detailed description is merely illustrative and is not intended to limit embodiments or application/uses of embodiments. Furthermore, there is no intention to be bound by any expressed or implied information presented in the preceding Background or Summary sections, or in the Detailed Description section.

One or more embodiments are now described with reference to the drawings, wherein like referenced numerals are used to refer to like elements throughout. In the following description, for purposes of explanation, numerous specific details are set forth in order to provide a more thorough understanding of the one or more embodiments. It is evident, however, in various cases, that the one or more embodiments can be practiced without these specific details.

Foundation models can have hierarchies ranging from general to specific. Various existing techniques construct foundation models with a top-down approach. In particular, foundation models are built from general to specific, meaning a general foundation model is adapted towards more specific hierarchy levels (e.g., adapted for specific tasks). For example, a computer vision foundation model can be adapted into a general segmenter, which can be further adapted into a medical image segmenter. The medical image segmenter can be even further adapted into an ultrasound medical image segmenter (e.g., Segment Anything Model (SAM) is adapted into a universal medical image segmenter (medSAM), which is further adapted into an ultrasound medical image segmenter (sonoSAM)).

Unfortunately, such existing techniques require an extensive amount of data to train a general foundation model, and can thus induce large computation costs and resources. Indeed, in order for a foundation model to be able to perform a wide variety of machine learning tasks, it must be extensively trained on a wide variety of datasets among a wide array of domains or fields. But after such extensive training, which can be computation-intensive and time-consuming, the foundation model can be unable to suitably specialize to more specific domains.

This struggle primarily stems from their general-purpose nature, as foundation models are trained on diverse datasets and tasks to serve as a starting point for various applications. When tasked with specialized domains, such as medical imaging, are desired to perform, such models may lack nuanced understanding or specific domain knowledge required for accurate predictions. Significant retraining for different fields is still needed to specialize the foundation model for that particular field.

For example, suppose that a foundation model is trained to accurately segment scanned images that pertain to computed tomography (CT) scanners. In such a case, the foundation model can be unable to accurately segment scanned images that pertain to magnetic resonance imaging (MRI) scanners or positron emission tomography (PET) scanners. In other words, the foundation model, having been trained in a CT domain, is not able to accurately function in an MRI domain or a PET domain. In still other words, the foundation model is not generalizable beyond the technical domain on which it was trained (at least without extensive retraining).

Furthermore, unfortunately, such existing techniques provide little control over data used to train the foundation model (e.g., little control over data variety or bias). Thus, bias that may be present in training data used to train the foundation model will be inherited by any model based on that foundation model. In other words, bias is inherited for all downstream tasks using the foundation model. Additionally, since training a foundation model requires an extensive amount of data, there is less control over types of data or specific data used. Therefore, any inaccuracies of the foundation model are inherited for all models based on the foundation model and carried through all downstream tasks. Moreover, for adaptation tasks to include data variety, existing techniques can require applying a variety-driven approach for each adaptation task, incurring more computation time and resources.

Accordingly, systems or techniques that can address one or more of these technical problems can be desirable.

Various embodiments described herein can address one or more of these technical problems. One or more embodiments described herein can include systems, computer-implemented methods, apparatus, or computer program products that can facilitate building of foundation models via a bottom-up process. In particular, the inventors of various embodiments described herein devised various techniques that enable foundation models to be constructed by task consolidation. Task consolidation is a pre-training task that builds a single model that learns a generalized representation of multiple downstream tasks. As described herein, the present inventors realized that a foundation model can be created via a bottom-up process by iteratively building generalized models that learn generalized representations of multiple downstream tasks. More specifically, the generalized models can be trained to recognize the multiple downstream tasks based on a vector prompt defined for each of the downstream tasks.

Various embodiments described herein can be considered as being advantageous over existing techniques. Indeed, the present inventors realized that task consolidation to build a foundation model via a bottom-up process can exhibit wider or broader generalizability and higher efficiency than top-down foundation models. In other words, a bottom-up foundation model can have a higher propensity for accurately or reliably adapting to other machine learning tasks, no matter the domain. Accordingly, a bottom-up foundation model can be accurately executed across different technical domains with a significant reduction in training, whereas a top-down foundation model cannot be accurately executed across different technical domains without extensive retraining. Moreover, a bottom-up foundation model can inherently perform multi-tasking efficiently and with significantly less parameters. Furthermore, a bottom-up foundation model can enable data variety control or control over bias in data by isolating bottom-up processes. Variety robustness can further be inherited and preserved for adaptation tasks, eliminating a need to apply variety-driven methods for each adaptation task and allowing for improved scalability of the bottom-up foundation model. The creation of such a bottom-up foundation model can be far less time-consuming and effort-intensive than extensively retraining a top-down foundation model. Therefore, various embodiments described herein can be considered as a more generalizable and efficient way of building foundation models, as compared to existing techniques.

Various embodiments described herein can be employed to use hardware or software to solve problems that are highly technical in nature (e.g., to facilitate building of foundation models via a bottom-up process), that are not abstract and that cannot be performed as a set of mental acts by a human. Further, some of the processes performed can be performed by a specialized computer (e.g., task consolidation executed on machine learning tasks) for carrying out defined acts related to foundation models. For example, such defined acts can include: accessing, by a device operatively coupled to a processor, a plurality of machine learning tasks; and building, by the device and in a bottom-up manner, a foundation model by recursively consolidating subsets of the plurality of machine learning tasks into generalized representations.

Such defined acts are not performed manually by humans. Indeed, neither the human mind nor a human with pen and paper can: electronically create a bottom-up built foundation model, by iteratively building intermediate models to learn generalized representations of its downstream tasks. Indeed, foundation models are inherently-computerized, hardware-based, or software-based constructs that simply cannot be meaningfully implemented, trained, or executed in any way by the human mind without computers. A computerized tool that can automatically build a foundation model via a bottom-up process and that can learn generalized representations of downstream tasks based on vector prompts is likewise inherently-computerized and cannot be implemented in any sensible, practical, or reasonable way without computers.

Moreover, various embodiments described herein can integrate into a practical application various teachings relating to building foundation models via a bottom-up process. Existing techniques build or construct foundation models via a top-down approach. Unfortunately, as the present inventors recognized, top-down foundation models can be considered as exhibiting poor generalizability across technical domains. Accordingly, existing techniques require extensive retraining every time an adapted model from a foundation model in a new technical domain is desired. Such extensive retraining can be considered as effort-intensive, time-consuming, or otherwise undesirable.

Various embodiments described herein can address one or more of these technical problems. In particular, the present inventors devised various techniques for constructing foundation models via a bottom-up process. Specifically, the present inventors recognized that bottom-up built foundation models can exhibit improved adaptability over top-down built foundation models. In various aspects, when given a plurality of machine learning tasks, various embodiments described herein can include building a foundation model via a bottom-up process, by iteratively building generalized models to learn generalized representations of the plurality of machine learning tasks. In various instances, the foundation model can have a hierarchy of intermediate models wherein the intermediate models learn generalized representations of its downstream tasks. In various cases, the intermediate models can learn the generalized representations of its downstream tasks by assigning vector prompts to the downstream tasks. In various aspects, the intermediate models can learn the generalized representations from data directly or from other intermediate models. In particular, multiple intermediate models of a same hierarchal level can be consolidated into a further generalized model. By iteratively building generalized models in this fashion, the foundation model can be constructed in a manner that overcomes problems previously described (e.g., less training data, less computation costs, data variety robustness, bias control, multi-task capabilities, scalability). Thus, various embodiments described herein can facilitate building of foundation models via a bottom-up process. Because bottom-up foundation models can exhibit greater generalizability than top-down foundation models (e.g., consider ChatGPT, which can be considered as a top-down foundation model that can be adapted to different technical domains), various embodiments described herein can be considered as an improved way of constructing foundation models, as compared to existing techniques. Thus, various embodiments described herein certainly constitute a tangible and concrete technical improvement or technical advantage in the field of foundation models. Accordingly, such embodiments clearly qualify as useful and practical applications of computers.

Furthermore, various embodiments described herein can control real-world tangible devices based on the disclosed teachings. For example, various embodiments described herein can electronically train and execute real-world machine learning models, so as to build real-world foundation models that represent technical features or fabrication information about real-world domains.

It should be appreciated that the herein figures and description provide non-limiting examples of various embodiments and are not necessarily drawn to scale.

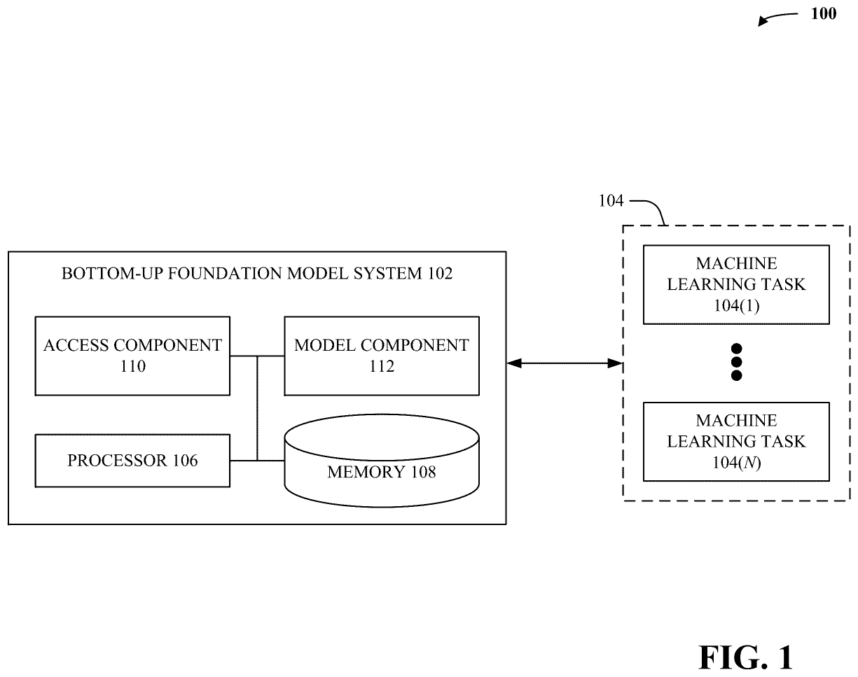

FIG. 1 illustrates a block diagram of an example, non-limiting system 100 that can facilitate building of foundation models via a bottom-up process in accordance with one or more embodiments described herein. System 100 can include or correspond to one or more computing devices, machines, virtual machines, computer-executable components, datastores, and the like that may communicatively coupled to one another either directly or via one or more wired or wireless communication frameworks.

In various cases, the plurality of machine learning tasks 104 can comprise N tasks, for any suitable positive integer N>1: a task 104(1) to a task 104(N). In various aspects, each of the plurality of machine learning tasks 104 can be any suitable machine learning task (e.g., type). For example, each of the plurality of machine learning tasks 104 can be any type of machine learning task (e.g., supervised learning, unsupervised learning, semi-supervised learning, reinforcement learning, classification, regression, clustering). Moreover, each of the plurality of machine learning tasks 104 can pertain to any domains, fields, or applications (e.g., healthcare, finance, manufacturing). For example, a task of the plurality of machine learning tasks 104 can be medical image segmentation. Furthermore, the plurality of machine learning tasks 104 can comprise any level of specificity. For example, the plurality of machine learning tasks 104 can be general, such as classification. Conversely, the plurality of machine learning tasks 104 can be specific, such as object detection for autonomous driving.

As a non-limiting example, any of the plurality of machine learning tasks 104 can be image segmentation. As another non-limiting example, any of the plurality of machine learning tasks 104 can be text generation. As still another non-limiting example, any of the plurality of machine learning tasks 104 can be text translation. As even another non-limiting example, any of the plurality of machine learning tasks 104 can be text-to-image synthesis. As yet another non-limiting example, any of the plurality of machine learning tasks 104 can be anomaly detection. As still another non-limiting example, any of the plurality of machine learning tasks 104 can be facial detection.

In any case, it can be desired to generate a foundation model to perform the plurality of machine learning tasks 104. As described herein, the bottom-up foundation model system 102 can facilitate or accomplish such objectives.

In various embodiments, the bottom-up foundation model system 102 can comprise a processor 106 (e.g., computer processing unit, microprocessor) and a non-transitory computer-readable memory 108 that is operably or operatively or communicatively connected or coupled to the processor 106. The non-transitory computer-readable memory 108 can store computer-executable instructions which, upon execution by the processor 106, can cause the processor 106 or other components of the bottom-up foundation model system 102 (e.g., access component 110, model component 112) to perform one or more acts. In various embodiments, the non-transitory computer-readable memory 108 can store computer-executable components (e.g., access component 110, model component 112), and the processor 106 can execute the computer-executable components.

In various embodiments, the bottom-up foundation model system 102 can comprise an access component 110. In various aspects, the access component 110 can electronically access the plurality of machine learning tasks 104. In various embodiments, the access component 110 can electronically access the plurality of machine learning tasks 104, such that the access component 110 can serve as a conduit through which other components of the bottom-up foundation model system 102 can electronically interact with the plurality of machine learning tasks 104.

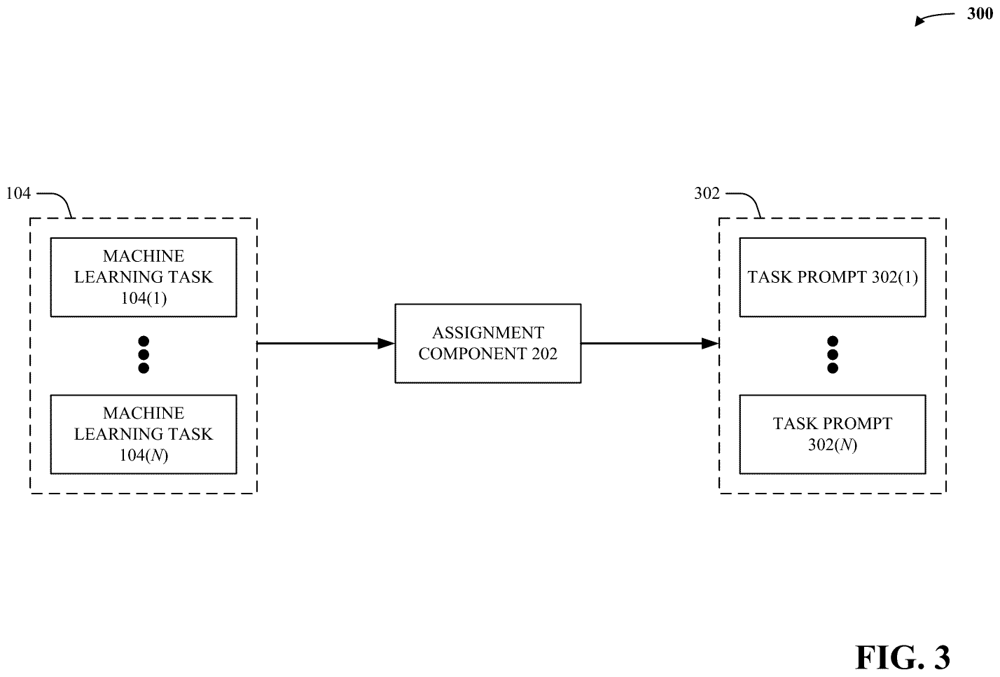

In various embodiments, the bottom-up foundation model system 102 can comprise a model component 112. In various aspects, as described herein, the model component 112 can build a foundation model by recursively consolidating subsets of the plurality of machine learning tasks 104 into generalized representations. Such consolidation can be facilitated through task consolidation of the plurality of machine learning tasks 104. Non-limiting aspects are described with respect to FIGS. 3-10.

Note that, in order for the bottom-up foundation model described herein to be accurate or reliable, the bottom-up foundation model should undergo training. Accordingly, the computerized tool described herein can comprise a training component that can facilitate such training in any suitable fashion (e.g., supervised fashion, unsupervised fashion, reinforcement learning fashion).

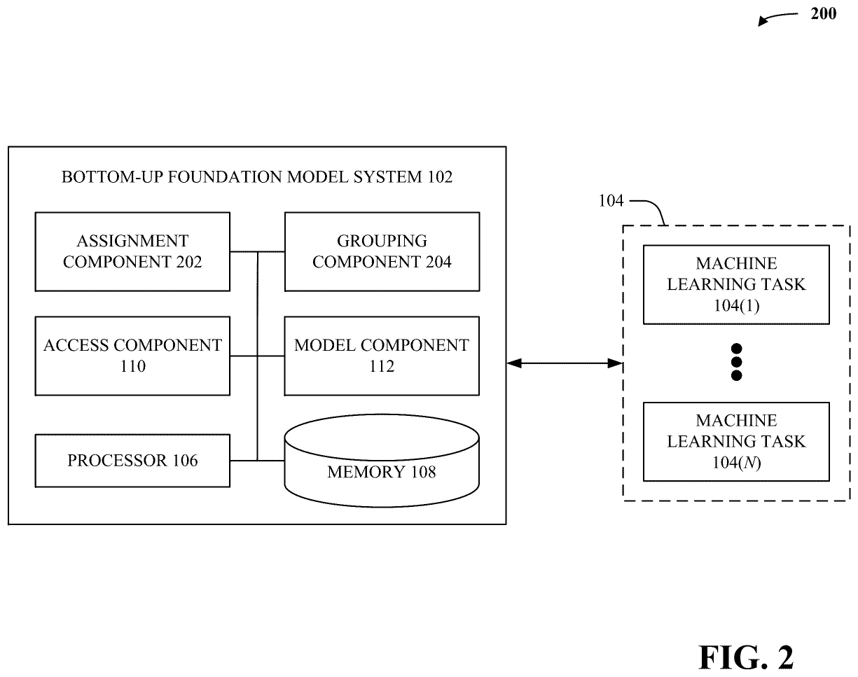

FIG. 2 illustrates a block diagram of an example, non-limiting system 200 including an assignment component and a grouping component that facilitates building of foundation models via a bottom-up process in accordance with one or more embodiments described herein. As shown, the system 200 can, in some cases, comprise the same components as the system 100, and can further comprise an assignment component 202 and a grouping component 204.

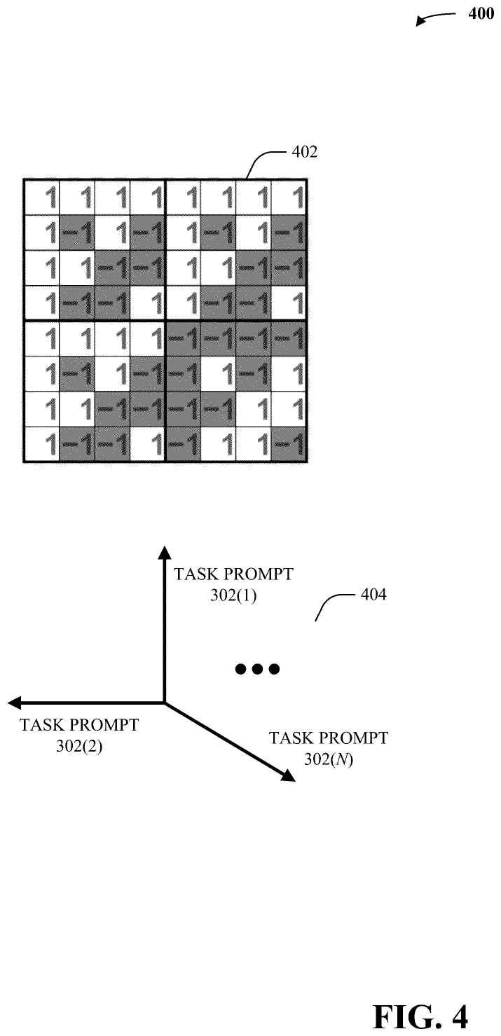

In various embodiments, the assignment component 202 can define task prompts 302 for the plurality of machine learning tasks 104. In various cases, the task prompts 302 can comprise N prompts: a prompt 302(1) to a prompt 302(N). In various aspects, the task prompts 302 can be defined as vectors. In various cases, the model component 112 can electronically retrieve or otherwise electronically obtain the tasks prompts 302, and thus the model component 112 can utilize the task prompts 302 to facilitate consolidation of subsets of the plurality of machine learning tasks 104 into generalized representations. Non-limiting aspects are described with respect to FIGS. 3 and 4.

In various embodiments, the model component 112 can engage the grouping component 304 to isolate bottom-up processes based on characteristics of the bottom-up processes. In other words, the grouping component 304 can group together subsets of the plurality of machine learning tasks 104 to be consolidated into a generalized representation as a single bottom-up process.

Such isolation of bottom-up processes can save computation time and resources. For example, if the plurality of machine learning tasks 104 comprises 100 tasks, the grouping component 304 can group the plurality of machine learning tasks 104 into subgroups each comprising 10 tasks, where each subgroup shares similar bottom-up processes (e.g., a subgroup comprises tasks for medical image enhancement, a subgroup comprises tasks for medical image lesion detection, a subgroup comprises tasks for radiomics). Thus, 10 bottom-up processes can be performed instead of 100 bottom-up processes, improving computation efficiency by reducing problem size.

As a non-limiting example, the grouping component 304 can isolate bottom-up processes involving X-ray image segmentation from bottom-up processes involving Magnetic Resonance Imaging (MRI) segmentation. As another non-limiting example, the grouping component 304 can isolate bottom-up processes involving MRI segmentation of the brain from bottom-up processes involving MRI segmentation of the knee. As yet another non-limiting example, the grouping component 304 can isolate bottom-up processes involving cerebellum MRI segmentation from bottom-up processes involving optic nerve MRI segmentation. As still another non-limiting example, the grouping component 304 can isolate bottom-up processes involving medical image segmentation from bottom-up processes involving satellite imagery segmentation. As even another non-limiting example, the grouping component 304 can isolate bottom-up processes involving image segmentation from bottom-up processes involving object recognition. As still another non-limiting example, the grouping component 304 can isolate bottom-up processes involving computer vision from bottom-up processes involving natural language processing (NLP).

FIG. 3 illustrates an example, non-limiting block diagram 300 that facilitates defining of prompts for machine learning tasks in accordance with one or more embodiments described herein.

As mentioned above, assignment component 202 can define task prompts 302 as vectors for the plurality of machine learning tasks 104. In various aspects, prompt 302(i) can correspond to task 104(i) for any positive integer i where i≤n. In other words, each prompt of the task prompts 302 uniquely corresponds to one task of the plurality of machine learning tasks 104. Therefore, during training of the foundation model, the foundation model can receive as input the task prompts 302 and the plurality of machine learning tasks 104 to learn to identify a task of the plurality of machine learning tasks 104 based on the prompt and produce the appropriate output for the task received as input. In various aspects, the assignment component 202 can electronically retrieve or otherwise electronically obtain the plurality of machine learning tasks 104, and produce the task prompts 302. Non-limiting aspects of generating the task prompts 302 are described with respect to FIG. 4.

FIG. 4 illustrates an example, non-limiting diagram 400 of orthogonal prompts for machine learning tasks in accordance with one or more embodiments described herein.

In various aspects, the generalized representations of the plurality of machine learning tasks 104 can be learned in their respective vector space in a decoupled manner. In various embodiments, such decoupled manner can comprise the assignment component 202 defining the task prompts 302 as orthogonal vectors (e.g., perpendicular vectors), as illustrated by vector space 404, to decouple task interference (e.g., interference between tasks from simultaneous learning of the tasks due to shared parameters of a model) for multi-task learning. However, the task prompts 302 do not need to be orthogonal and can be defined in any suitable manner so as to enable task consolidation. A set of vectors can be considered orthogonal if the dot product of any two vectors within the set is 0. In various aspects, the assignment component 202 can mathematically encode the task prompts 302 such that each prompt of the task prompts 302 lies in their own space within the vector space 404. Therefore, access to one prompt in the task prompts 302 will not change or affect another prompt, and thus decoupling task interference. As an example, the assignment component 202 can employ Hadamard code to generate the task prompts 302 as orthogonal vectors, however, the assignment component 202 can employ any suitable mathematical encoding techniques to generate the task prompts 302 as orthogonal vectors. Hadamard code is an error-detecting code where the distance, 2^{k}−1 where k is the number of bits in the prompt, between each prompt is identical and, the projections of any embedding on the vector space 404 is independent of other projections. The Hadamard code for the vectors can be constructed by defining each vector as a row (or column) of the Hadamard matrix. For example, in the case n=8 where the plurality of machine learning tasks 104 comprises 8 tasks, Hadamard matrix 402 can be used to define eight vectors, v₁, v₂, . . . , v₈, as the task prompts 302. Each of the vectors (e.g., v₁, v₂, . . . , v₈) can be defined by each row of the Hadamard matrix 402 (e.g., v₁=[1, 1, 1, 1, 1, 1, 1, 1], v₂=[1, −1, 1, −1, 1, −1, 1, −1], v₃=[1 ,1, −1, −1, 1, 1, −1, −1]).

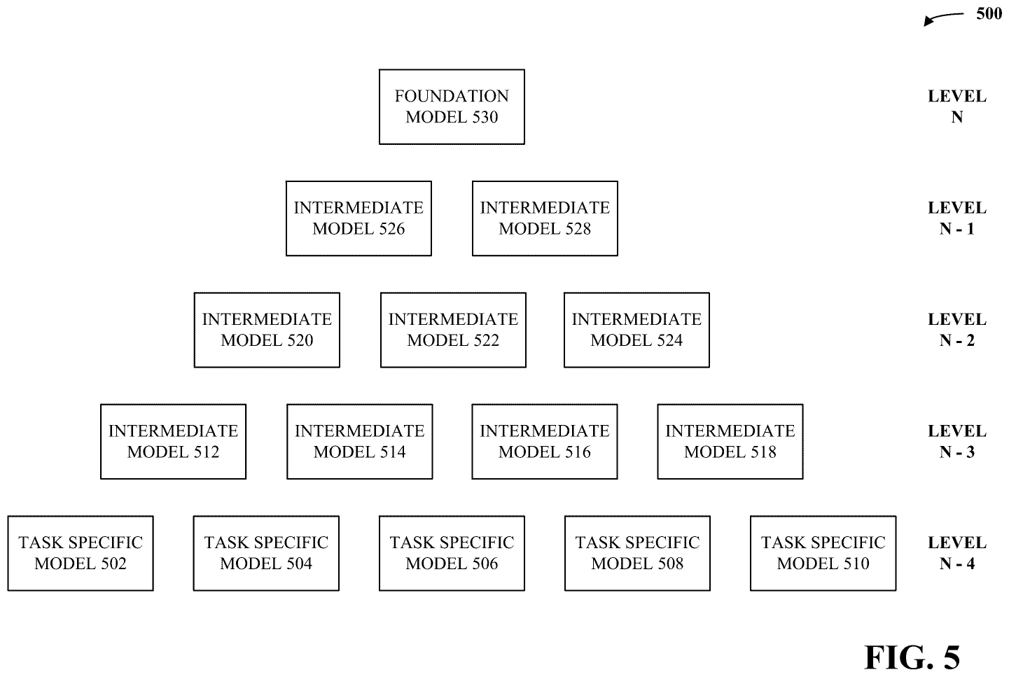

FIG. 5 illustrates an example, non-limiting block diagram 500 of a foundation model hierarchy in accordance with one or more embodiments described herein.

In various embodiments, a foundation model can comprise any number of hierarchal levels N. As previously described, current methods of building foundation models comprise a top-down approach, meaning the foundation model is first trained and then adapted to more specific models. For example, foundation model 530 can be adapted to create more specialized models such as intermediate model 526 or intermediate model 528 at level N−1 of the hierarchy. In the top-down approach, intermediate model 526 and intermediate model 528 can be adapted into even further specific models at level N−1 of the hierarchy. This top-down approach can be continuously applied until the intermediate models are adapted into task-specific models (e.g., task-specific model 502, task-specific model 504, task-specific model 506, task-specific model 508, task-specific model 510). However, such top-down approach necessitates extensive retraining to create the adapted models in lower levels of the foundation model hierarchy.

Various embodiments described herein overcome such a problem by building the foundation model 530 via a bottom-up process. More specifically, instead of adapting a general model into more specific models, the more specific models are consolidated to form the general model. Such consolidation of models can be performed through task consolidation. In various aspects, any configuration of subsets of the task-specific models (e.g., 502, 504, 506, 508, 510) can be consolidated into any number of intermediate models (e.g., 512, 514, 516, 518). In various cases, any of the intermediate models can be further consolidated into any number of intermediate models (e.g., 520, 522, 524). In some instances, the further consolidated intermediate models can be even further consolidated into more generalized intermediate models (e.g., 526, 528). As a non-limiting example, task-specific model 502 and task-specific model 504 can be consolidated to create intermediate model 512. As another non-limiting example, task-specific model 506, task-specific model 508, and task-specific model 510 can be consolidated to create intermediate model 516. As yet another non-limited example, intermediate model 526 and intermediate model 528 can be consolidated to create the foundation model 530.

Note that, in various instances, task consolidation does not need to be performed throughout the entire foundation model hierarchy to form foundation model 530. In other words, the bottom-up approach allows for building a model only for what is desired, saving computation time and costs. In some cases, a more generalized model than intermediate model 526 may not be desired. Accordingly, further generalizing and training to create foundation model 530 can be forgone, and thus saving unnecessary computation resources. In such a case, the desired model can be considered as the foundation model (e.g., intermediate model 526 is considered the foundation model if further generalization is not desired). For example, a model that can generalize to healthcare fields and autonomous driving may not be desirable to an organization in the autonomous driving field. Therefore, extent of diversity of training data for the model can be reduced and allow the model to be trained on data that only pertains to autonomous driving. Conversely, in a top-down approach, a general model that does necessitate a highly diverse and extensive amount of training data is built first. Then, more specific models can be adapted into the desired field or specialty. Such an approach consumes unnecessary computation resources that enable the foundation model 530 to perform tasks that are not desirable to perform.

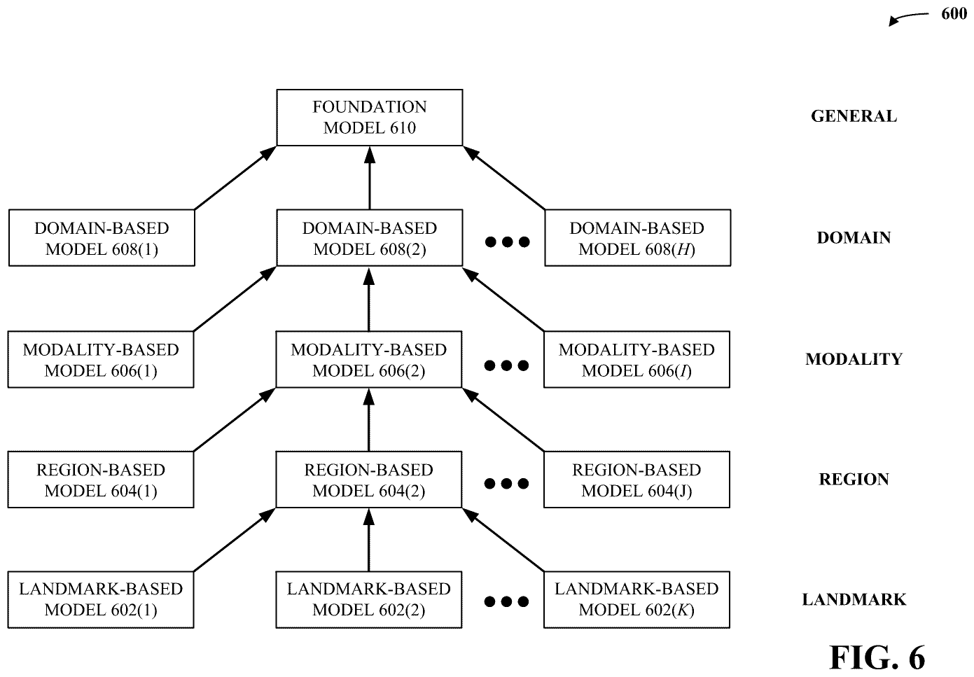

FIG. 6 illustrates an example, non-limiting block diagram 600 that facilitates building of foundation models via a bottom-up process for healthcare related fields in accordance with one or more embodiments described herein.

As a non-limiting example, a foundation model 610 can be trained for image segmenting, particularly medical image segmenting. In various aspects, foundation model 610 can comprise the following hierarchal levels in order from specific to general: landmark, region, modality, domain, and general. In medical image segmenting, landmarks can comprise specific structures in parts or organs of a body (e.g., cerebellum, hippocampus, optic nerve). In some cases, regions can comprise a region of the body (e.g., body, brain, knee). In various aspects, modality can comprise types of imaging technologies (e.g., X-ray, MRI, CT). In various cases, domain can be any field or domain (e.g., medical image segmentation, satellite image segmentation, image segmentation for surveillance video analysis).

As illustrated, landmark-based models 602 can comprise K models, for any positive integer K>1: a model 602(1) a model 602(K). In various aspects, subsets of the landmark-based models 602 can be consolidated to form region-based models 604. The region-based models 604 can comprise J models, for any positive integer J>1: a model 602(1) a model 602(J). In various cases, subsets of the region-based models 604 can be consolidated to form modality-based models 606. The modality-based models 606 can comprise I models, for any positive integer I>1: a model 602(1) a model 602(I). In various aspects, subsets of the modality-based models 606 can be consolidated to form domain-based models 608. The domain-based models 608 can comprise H models, for any positive integer H>1: a model 602(1) a model 602(H).

As a non-limiting example, landmark-based model 602(1) can perform MRI image segmentation of a cerebellum, landmark-based model 602(2) can perform MRI image segmentation of a hippocampus, and landmark-based model 602(3) can perform MRI image segmentation of optic nerves. In various embodiments, the landmark-based model 602(1), landmark-based model 602(2), and landmark-based model 602(3) can be consolidated into region-based model 604(2), wherein the region-based model 604(2) performs MRI image segmentation of a brain. In various cases, region-based model 604(1) can perform MRI image segmentation of a body and region-based model 604(3) can perform MRI image segmentation of a knee. In various embodiments, region-based model 604(1), region-based model 604(2), and region-based model 604(3) can be consolidated into modality-based model 606(2), wherein the modality-based model 606(2) performs MRI medical image segmentation. In some cases, modality-based model 606(1) can perform X-ray medical image segmentation and modality-based model 606(3) can perform CT medical image segmentation. In various embodiments, modality-based model 606(1), modality-based model 606(2), and modality-based model 606(3) can be consolidated into domain-based model 608(2), wherein domain-based model 608(2) performs medical image segmentation. In some cases, domain-based model 608(1) can perform satellite image segmentation and domain-based model 608(3) can perform image segmentation for surveillance video analysis. In various embodiments, domain-based model 608(1), domain-based model 608(2), and domain-based model 608(3) can be consolidated into foundation model 610, wherein the foundation model 610 can perform image segmentation across various domains.

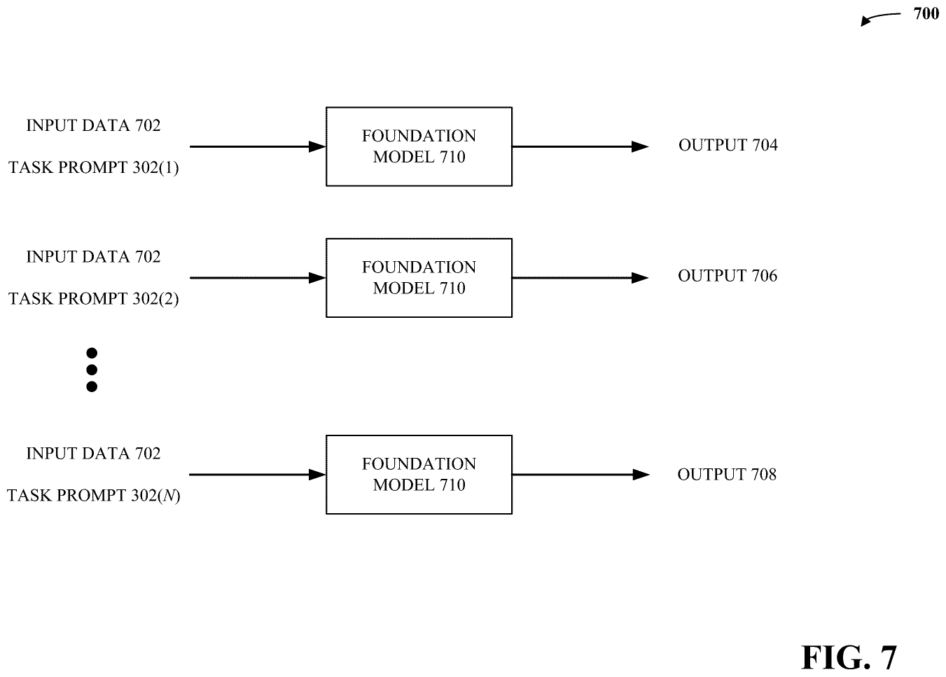

FIG. 7 illustrates an example, non-limiting block diagram 700 of multi-task learning of a bottom-up foundation model in accordance with one or more embodiments described herein.

After training of a foundation model 710 built via a bottom-up process (e.g., task consolidation of models), the foundation model 710 can inherently perform multi-tasking by receiving the task prompts 302. In other words, the foundation model 710 can directly perform different tasks of the plurality of machine learning tasks 104 by receiving corresponding prompts of the task prompts 302. Therefore, the foundation model 710 can produce correct output for a desired task and input data based on the prompt received. For example, foundation model 710 can receive input data 702 and task prompt 302(1) to produce output 704, wherein the output 704 correctly corresponds to a task of the plurality of machine learning tasks 104. In other cases, foundation model 710 can receive input data 702 and task prompt 302(2) to produce output 706, wherein the output 706 correctly corresponds to a task of the plurality of machine learning tasks 104. Similarly, an output 708 that correctly corresponds to any task of the plurality of machine learning tasks 104 can be produced by the foundation model 710 for input data 702 by receiving a corresponding prompt of the task prompts 302.

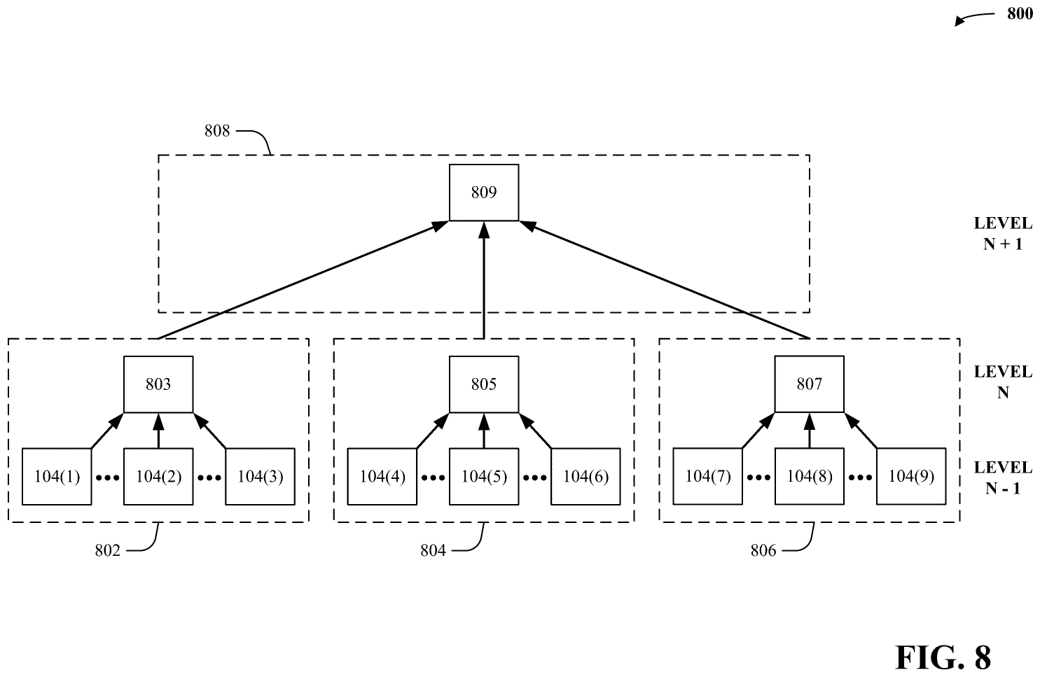

FIG. 8 illustrates an example, non-limiting block diagram 800 that facilitates isolation of bottom-up processes in accordance with one or more embodiments described herein.

In various aspects, the grouping component 204 can isolate independent bottom-up processes at a lower level (N+1) within a hierarchy N of the foundation model based on characteristics of the bottom-up processes. For example, bottom-up processes can be isolated based on region or modality in medical imaging. In various cases, outcomes of the isolated bottom-up processes can be further isolated at an upper level (N−1) of the hierarchy N. For example, outcomes of an isolated bottom-up process 802, an isolated bottom-up process 804, and an isolated bottom-up process 806 (e.g., 803, 805, 807) can be further isolated into a bottom-up process 808.

In various embodiments, the grouping component 204 can access the plurality of machine learning tasks 104 to isolate subgroups of the plurality of machine learning tasks 104 as a single bottom-up process. For example, the isolated bottom-up process 802 can include consolidating task 104(1), task 104(2), and task 104(3) into intermediate model 803. As another example, the isolated bottom-up process 804 can include consolidating task 104(4), task 104(5), and task 104(6) into intermediate model 805. Similarly, the isolated bottom-up process 802 can include consolidating task 104(7), task 104(8), and task 104(9) into intermediate model 807 e.g., an intermediate model 807). Although bottom-up processes depicted in FIG. 8 each comprise consolidating three tasks of the plurality of machine learning tasks 104, any number of tasks can be consolidated in a bottom-up process. Furthermore, any suitable configuration of subsets of the plurality of machine learning tasks 104 can be consolidated (e.g., consolidating task 104(2), task 104(5), and task 104(9). As a non-limiting example, task 104(1), task 104(2), and task 104(3) in isolated bottom-up process 802 can be grouped based on training datasets (e.g., isolated bottom-up process 802 can include tasks trained on chest X-ray images). In any case, any number of bottom-up process can be isolated and comprise any number of the plurality of machine learning tasks 104. Furthermore, the isolated bottom-up processes can be performed individually or in parallel.

Isolation of bottom-up processes can enable control over bias that may be present in training data and full control over hierarchical structure of the foundation model. Such a level of control can save computation time and resources by allowing the foundation model to be built for what is desired. Even so, the foundation model can efficiently and reliably adapt to other tasks after the foundation model is built. For example, bottom-up processes can be isolated in such a way that saves computation resources by building a foundation model to a lower hierarchy level for applications that only necessitate a lower hierarchy.

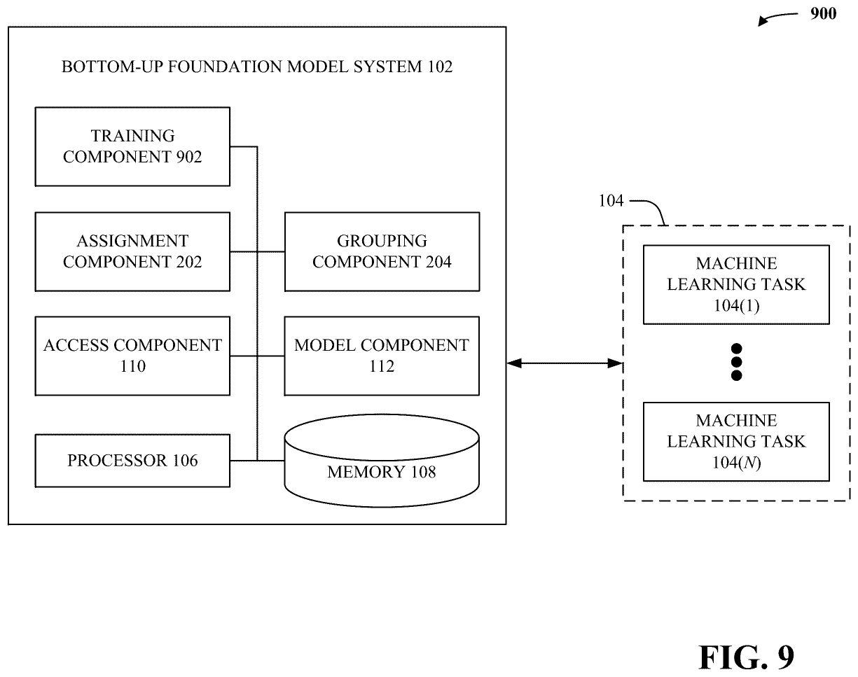

FIG. 9 illustrates an example, non-limiting system 900 including a training component that facilitates building of foundation models via a bottom-up process in accordance with one or more embodiments described herein. As shown, the system 900 can, in some cases, comprise the same components as the system 200, and can further comprise a training component 902.

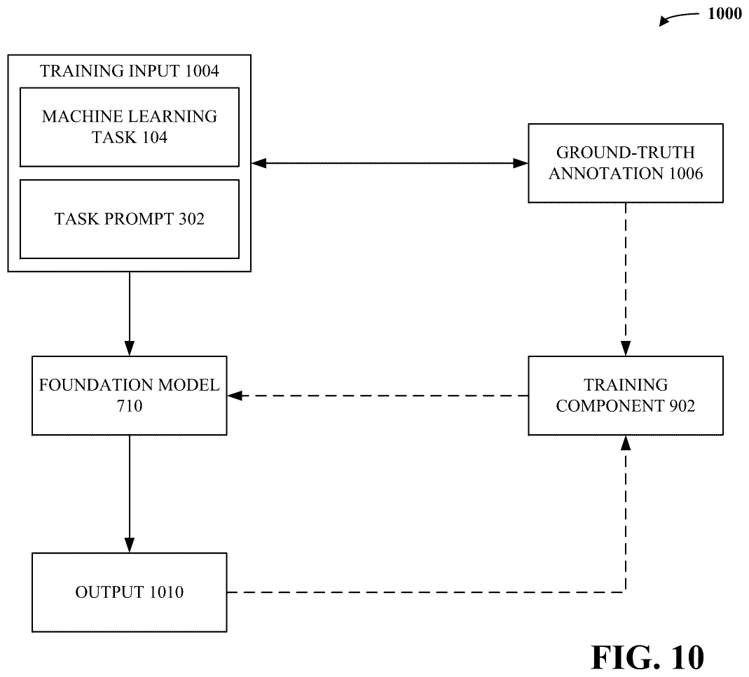

As shown, the system 900 can, in some cases, comprise the same components as the system 200, and can further comprise a training component 902. In various instances, the training component 902 can train the foundation model 710. Note that, training of the foundation model 710 can refer to training of any of the intermediate models that can be further consolidated to form the foundation model 710. In such cases, the training component 902 can train the intermediate models with training methods described herein. In some cases, such training can be facilitated in a supervised fashion, as described with respect to FIG. 10.

FIG. 10 illustrates an example, non-limiting block diagram 1000 that facilitates task consolidation by training of a foundation model with machine learning task prompts in accordance with one or more embodiments described herein.

In various aspects, prior to beginning training, the training component 902 can initialize in any suitable fashion (e.g., via random initialization) trainable internal parameters (e.g., convolutional kernels, weight matrices, bias values) of the foundation model 710 (or intermediate models).

In various embodiments, to facilitate task consolidation, there can be a training input 1004 and a ground-truth annotation 1006. When it is desired to train the foundation model 710, the training input 1004 can comprise the plurality of machine learning tasks 104 and the corresponding task prompts 302. The ground-truth annotation 1006 can be correct or accurate task output that is known or deemed to correspond to the training input 1004. Note that, if the foundation model 710 has so far undergone no or little training, then the output 1010 can be highly inaccurate. In other words, the output 1010 can be very different from the ground-truth annotation 1006.

In various aspects, the training component 902 can execute the foundation model 710 on the training input 1004, thereby causing the foundation model 710 to produce an output 1010. More specifically, in some cases, the training component 902 can feed or route the training input 1004 to the input layer of the foundation model 710, the training input 1004 can complete a forward pass through the one or more hidden layers of the foundation model 710, and the output layer of the foundation model 710 can compute the output 1010 based on activation maps or feature maps provided by the one or more hidden layers of the foundation model 710.

Note that the format, size, or dimensionality of the output 1010 can be dictated by the number, arrangement, sizes, or other characteristics of the neurons, convolutional kernels, or other internal parameters of the output layer (or of any other layers) of the foundation model 710. Accordingly, the output 1010 can be forced to have any desired format, size, or dimensionality, by adding, removing, or otherwise adjusting characteristics of the output layer (or of any other layers) of the foundation model 710.

In various aspects, the training component 902 can compute an error (e.g., mean absolute error (MAE), mean squared error (MSE), cross-entropy error) between the output 1010 and the ground-truth annotation 1006. In various instances, the training component 902 can incrementally update the trainable internal parameters of the foundation model 710, via backpropagation (e.g., stochastic gradient descent) based on the computed error.

In various cases, such execution-and-update procedure can be repeated for any suitable number input-annotation pairs. This can ultimately cause the trainable internal parameters of the foundation model 710 to become iteratively optimized for accurately generating output that corresponds to an input task and prompt. In various aspects, the training component 902 can utilize any suitable training batch sizes, any suitable error/loss functions, or any suitable training termination criteria.

Although the herein disclosure mainly describes the foundation model 710 as being trained in supervised fashion, this is a mere non-limiting example for case of explanation and illustration. In various embodiments, any other suitable training paradigm can be used to train the foundation model 710, such as unsupervised training or reinforcement learning.

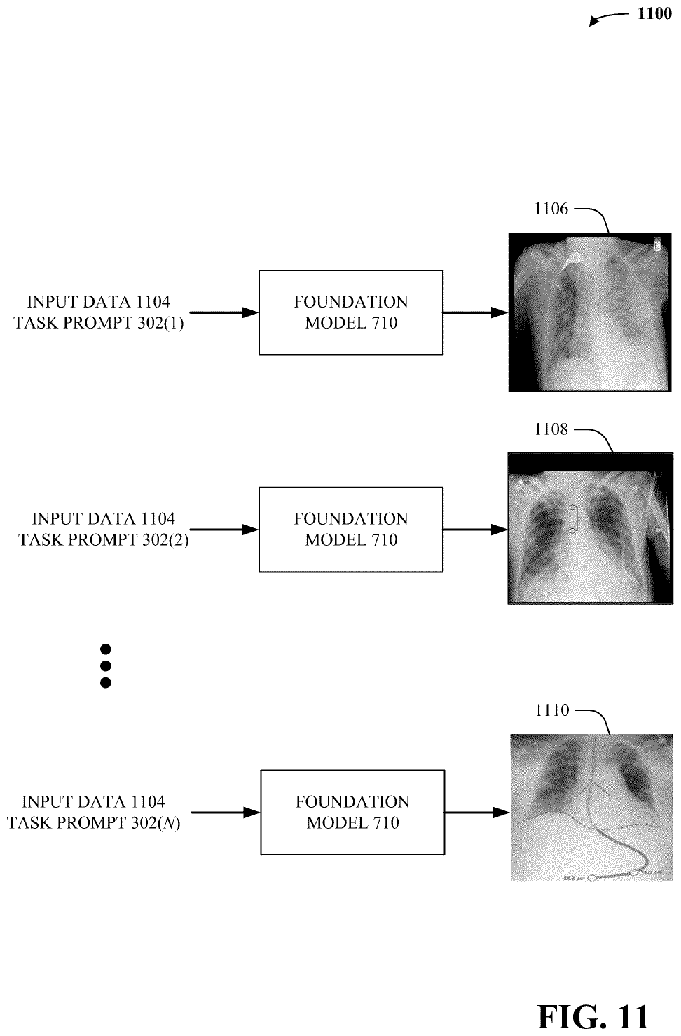

FIG. 11 illustrates an example, non-limiting block diagram 1100 of multi-task learning with machine learning task prompts in accordance with one or more embodiments described herein.

In various aspects, the bottom-up foundation model system 102 can build a foundation model that inherently performs multi-task learning. Multi-task learning is enabled by utilization of the task prompts 302. More specifically, after training, the foundation model can receive input data and a prompt from the task prompts 302 that corresponds to a task of the plurality of machine learning tasks 104 to produce a correctly corresponding output to the input task. As a non-limiting example, FIG. 10 depicts multi-task learning by the foundation model 710 where the foundation model 710 is trained for medical image processing.

In particular, the foundation model 710 can receive input data 1104(e.g., an image of a chest X-ray) and, based on a desired outcome, a prompt from task prompts 302. For example, task prompt 302(1) can correspond to a task for organ detection. As another example, task prompt 302(2) can correspond to a task for measuring length of a bone. As yet another example, task prompt 302(N) can correspond to a task for fluid detection. In any case, the foundation model 710 can produce output that accurately corresponds to the task identified by the input prompt (e.g., 1106, 1108, 1110). For example, the foundation model 710 can produce image 1106 as output if task prompt 302(1) is received, where image 1106 depicts a chest X-ray with a highlighted detected organ. As another example, the foundation model 710 can produce image 1108 as output if task prompt 302(2) is received, where image 1108 depicts a chest X-ray with a measured length of a particular bone. As yet another example, the foundation model 710 can produce image 1110 as output if task prompt 302(N) is received, where image 1108 depicts a chest X-ray with a highlighted tube of fluid.

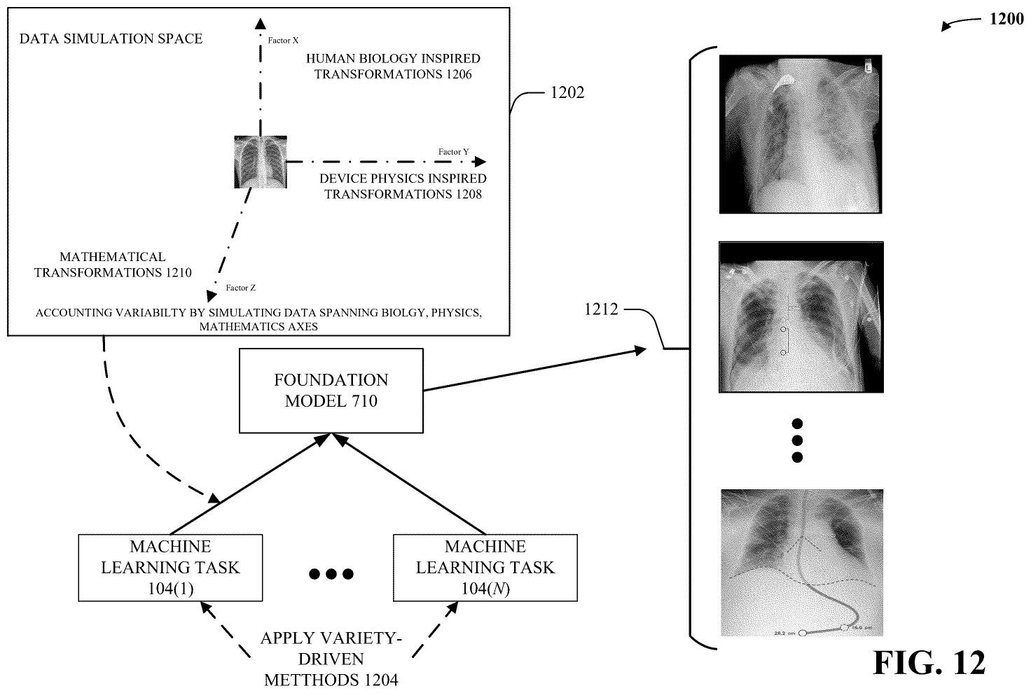

FIG. 12 illustrates an example, non-limiting block diagram 1200 that facilitates training a bottom-up foundation model with variety robustness in accordance with one or more embodiments described herein.

In various embodiments, the training component 902 can train the foundation model 710 with a variety-driven approach to build the foundation model 710 with variety robustness. For example, the training component 902 can train the foundation model 710 by applying data simulation or data augmentation to account for all edge cases in the foundation model 710. In various aspects, the training component 902 can apply data simulation by generating synthetic data that mimics characteristics of real-world data, enabling the foundation model 710 to learn from a wider range of scenarios for improved performance. In various cases, the training component 902 can apply data augmentation by artificially expanding a training dataset by applying various transformations (e.g., rotation, flipping, or cropping a dataset).

As a non-limiting example, as illustrated in FIG. 12, the foundation model 710 can be trained for medical image segmenting with variety robustness by applying variety-driven methods 1204 to training datasets for the plurality of machine learning tasks 104. As shown, variety-driven methods 1204 can include performing data transformations based on different domains on simulated data in a data simulation space 1202. As an example, human biology-based transformations 1206 can be applied to a factor x in the data simulation space 1202, and can include, but are not limited to, comorbidity insertion, internal object insertion, external object insertion, medical objects induced artifacts, or spatial registration-based object insertion (e.g., pacemakers with respect to body size). As another example, device physics-based transformations 1208 can be applied to a factor y in the data simulation space 1202, and can include, but are not limited to, gamma, median blur, motion blur, brightness, contrast, imaging artifacts insertion, noise insertion, texture insertion, variation in field of view, or resolution. As yet another example, mathematical-based transformations 1210 can be applied to a factor z in the data simulation space 1202, and can include, but are not limited to, affine transform, elastic transform, flip, rotate, grid distortion, center crop, perspective, pan, magnification, harmonization between datasets, or histogram equalization.

In various cases, variety-driven methods 1204 can be applied to any training datasets of any tasks of the plurality of machine learning tasks 104 (e.g., can be applied to a subset of datasets, can be applied to all datasets). Furthermore, different variety-driven methods can be applied to different tasks of the plurality of machine learning tasks 104. For example, data augmentation performed on one dataset can involve mathematical-based transformations and data augmentation on a different dataset can involve human-biology-based transformations. Furthermore, such methods enable control of variety in the foundation model 710 by isolation of bottom-up processes as described with respect to FIG. 8. Moreover,

In any case, such variety driven methods can cause the foundation model 710 (or intermediate models) to have variety robustness from consolidation of the plurality of machine learning tasks 104 or intermediate models. In other words, variety robustness is preserved for downstream tasks and is inherited by the resulting generalized models after task consolidation. Thus, for example, the foundation model 710 can handle edge cases for any of the plurality of machine learning tasks 104 and improve adaptability of the foundation model 710 to produce accurate output (e.g., output 1212) for other adaptation tasks without training the other adaptation tasks with variety-driven methods. Such aspect can further improve efficiency of task adaptation by decreasing training time and computation resources for training the foundation model 710.

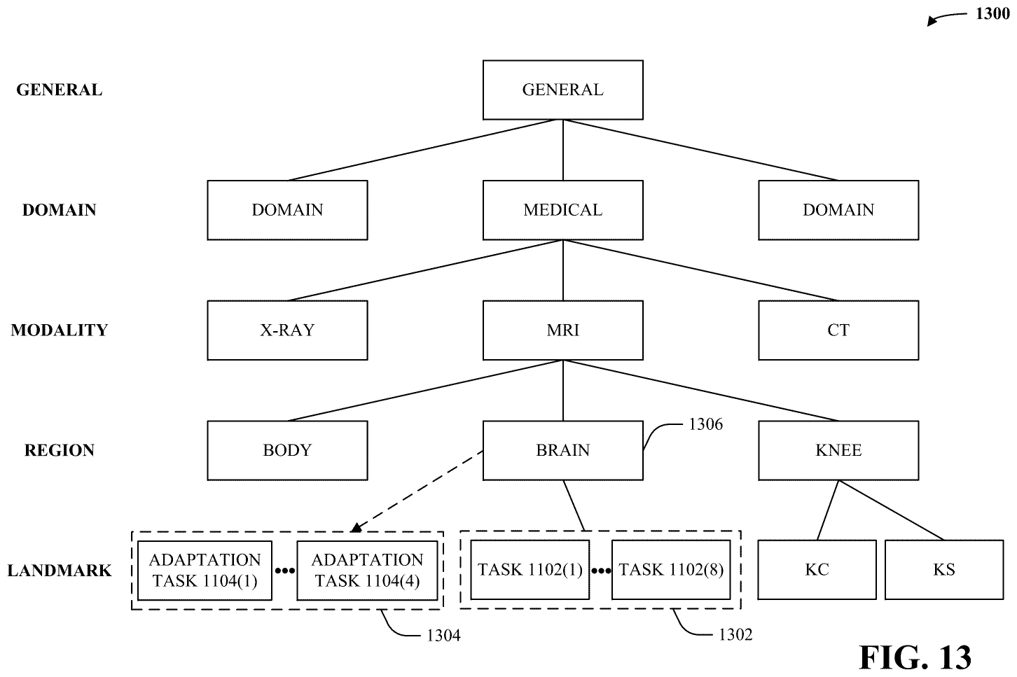

FIG. 13 illustrates an example, non-limiting block diagram 1300 of task adaptation via a bottom-up built foundation model in accordance with one or more embodiments described herein.

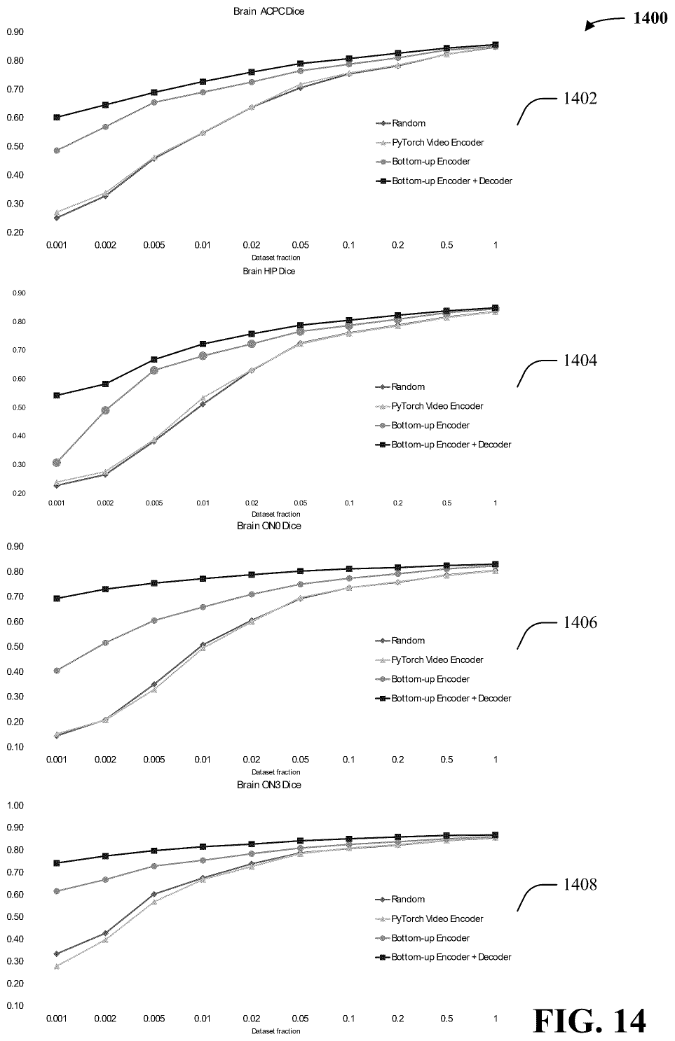

Illustrated in FIG. 13 is a pre-trained foundation model created via a bottom-up process using three-dimensional MRI brain data. Furthermore, the pre-trained foundation model comprises a same hierarchal structure as foundation model 610 (e.g., landmark, region, modality, domain, general). The three-dimensional MRI brain data includes 12 tasks (e.g., landmarks). Of the 12 tasks, eight tasks are used to build the pre-trained foundation model (e.g., tasks 1302): a task 1302(1) to a task 1302(8). The remaining four tasks are used as adaptation tasks (e.g., adaptation tasks 1304): an adaptation task 1304(1) to an adaptation task 1304(4). The tasks 1302 used to build the pre-trained foundation model comprise internal auditory canal (IAC), pituitary gland (PIT), mid sagittal plane-axial (MSPA), mid sagittal plane-coronal (MSPC), and four optic nerve system (ON) sub-tasks (e.g., ON1, ON2, ON4, ON5). The adaptation tasks 1304 comprise anterior commissure-posterior commissure line (ACPC), hippocampus (HIP), and two ON sub-tasks (e.g., ON0, ON3). In various aspects, the tasks 1302 are used to build pre-trained weights of the pre-trained foundation model that are used to adapt the pre-trained foundation model to the adaptation tasks 1304. Evaluation results of how the pre-trained foundation model adapts to adaptation tasks of a same region 1306 (e.g., brain region) are described with respect to FIG. 14.

FIG. 14 illustrates an example, non-limiting diagram 1400 of foundation model performance for task adaptation in accordance with one or more embodiments described herein.

Illustrated in FIG. 14 are four graphs (e.g., 1402, 1404, 1406, 1408) that plot dice scores (e.g., metric to evaluate performance of models in segmentation tasks that provides a measure of how well a predicted segmentation aligns with a ground truth) against fraction of training dataset used, wherein each graph corresponds to one of the adaptation tasks 1304. Note that, for each adaptation task, the foundation model is evaluated on 10 fractions of the training dataset used, where each training dataset fraction corresponds to an independent training, resulting in 10 models created and evaluated. Furthermore, foundation model performance is evaluated for four pre-trained weights (e.g., randomly initialized weights, encoder weight trained on a video dataset, pre-trained encoder weight created via a bottom-up process, pre-trained encoder and decoder weight created via a bottom-up process).

As shown, the pre-trained encoder weight created via a bottom-up process significantly outperform the randomly initialized weights and encoder weight trained on a video dataset. In particular, in a few-shot learning setting (e.g., small fraction of training dataset used), the pre-trained encoder weight achieves significantly greater dice scores for each of the adaptation tasks 1304 than the randomly initialized weights and encoder weight trained on a video dataset, thereby indicating improved foundation model adaptation performance for region-level task adaptation with few training datapoints. Furthermore, as shown, the pre-trained decoder weight created via a bottom-up process can further improve foundation model adaptation performance in a few-shot learning setting for adaptation tasks of a same region.

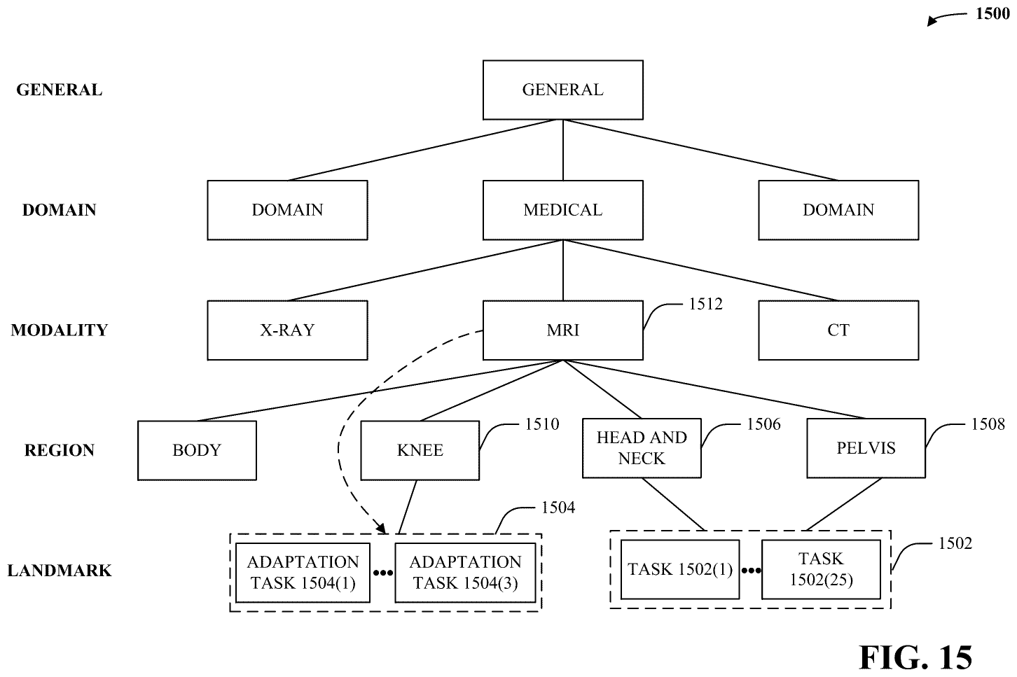

FIG. 15 illustrates an example, non-limiting block diagram 1500 of task adaptation via a bottom-up built foundation model in accordance with one or more embodiments described herein.

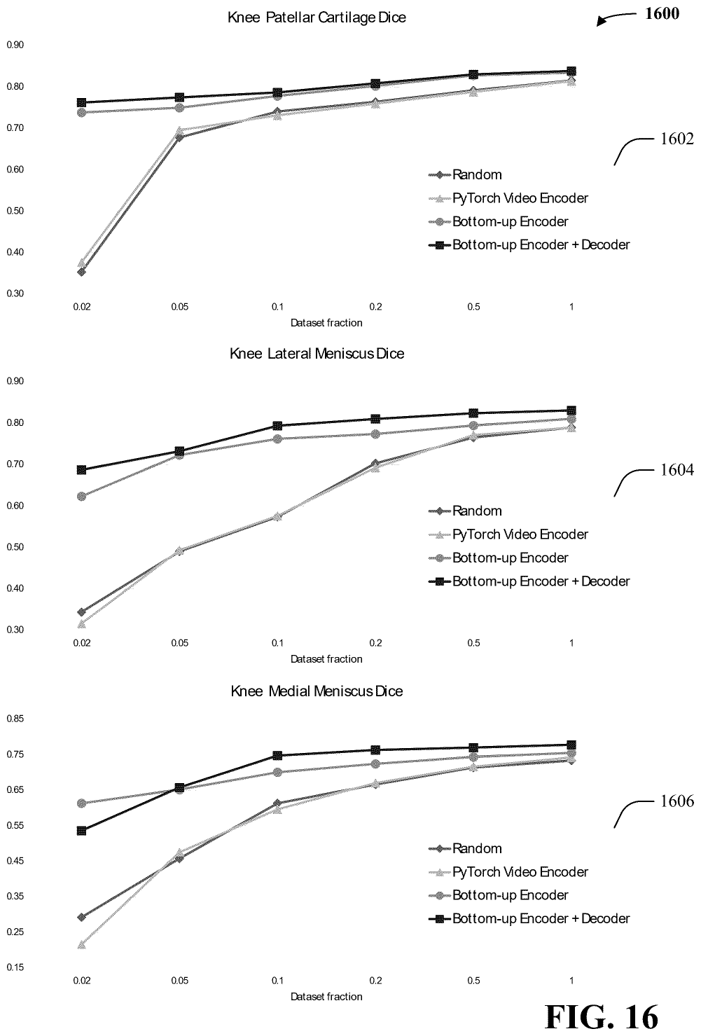

Illustrated in FIG. 15 is a pre-trained foundation model created via a bottom-up process using three-dimensional MR-OAR brain data. Furthermore, the pre-trained foundation model comprises a same hierarchal structure as foundation model 610 (e.g., landmark, region, modality, domain, general). The three-dimensional MR-OAR brain data includes 25 tasks (e.g., landmarks). The 25 tasks are used to build the pre-trained foundation model (e.g., tasks 1502): a task 1502(1) to a task 1502(25). The tasks 1302 used to build the pre-trained foundation model comprise landmarks in a head and neck region 1506, as well as in a pelvis region 1508. The adaptation tasks 1504 comprise three landmarks in a new region 1510 of and of a same modality 1512 as region 1506 and region 1508 (e.g., patellar cartilage, lateral meniscus, and medial meniscus of a knee region). In various aspects, the tasks 1502 are used to build pre-trained weights of the pre-trained foundation model that are used to adapt the pre-trained foundation model to the adaptation tasks 1504. Evaluation results of how the pre-trained foundation model adapts to adaptation tasks of the new region 1510 (e.g., the knee region) are described with respect to FIG. 16.

FIG. 16 illustrates an example, non-limiting diagram 1600 of model performance for task adaptation in accordance with one or more embodiments described herein.

Model setup used for evaluation of model performance is the same as the model setup described in FIG. 14 (e.g., 10 training dataset fractions evaluated for each adaptation task, dice score evaluated against training dataset fraction used, evaluated for the four pre-trained weights).

As shown in graph 1602, graph 1604, graph 1606, and graph 1608, for each of the adaptation tasks 1504, the pre-trained encoder weight created via a bottom-up process significantly outperform the randomly initialized weights and encoder weight trained on a video dataset. In particular, in a few-shot learning setting (e.g., small fraction of training dataset used), the pre-trained encoder weight achieves significantly greater dice scores for each of the adaptation tasks 1504 than the randomly initialized weights and encoder weight trained on a video dataset, thereby indicating improved foundation model adaptation performance for modality-level task adaptation with few training datapoints. Furthermore, as shown, the pre-trained decoder weight created via a bottom-up process can further improve foundation model adaptation performance in a few-shot learning setting for adaptation tasks of a new region. Thus, a bottom-up foundation model demonstrates improved adaptation to tasks at multiple hierarchy levels.

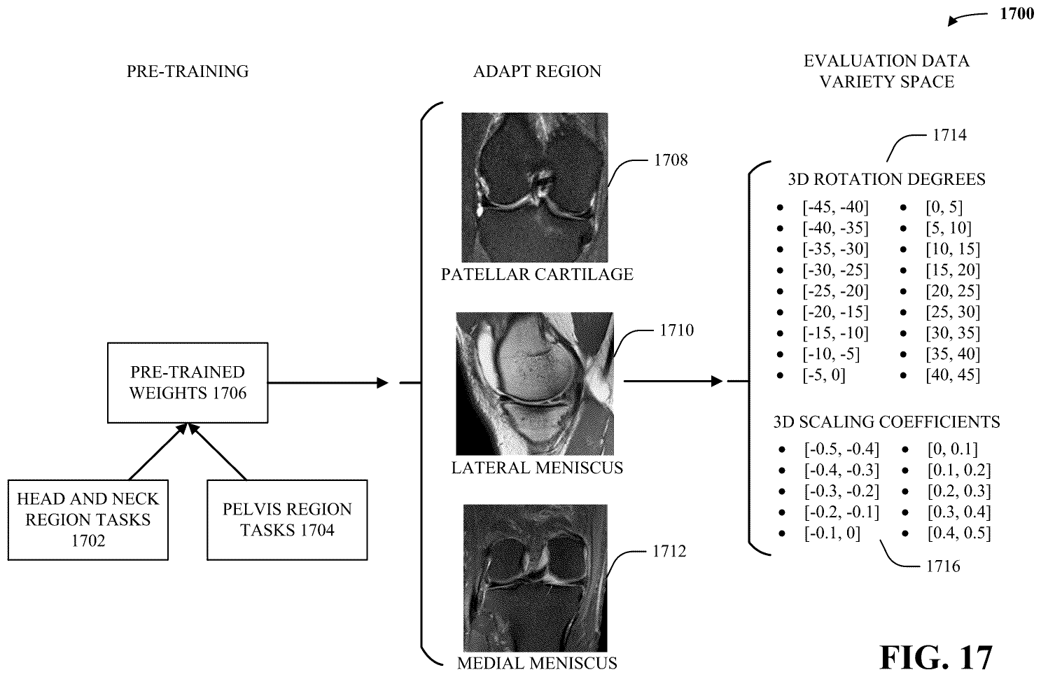

FIG. 17 illustrates an example, non-limiting diagram 1700 of creating pre-trained weights with variety robustness for task adaptation in accordance with one or more embodiments described herein.

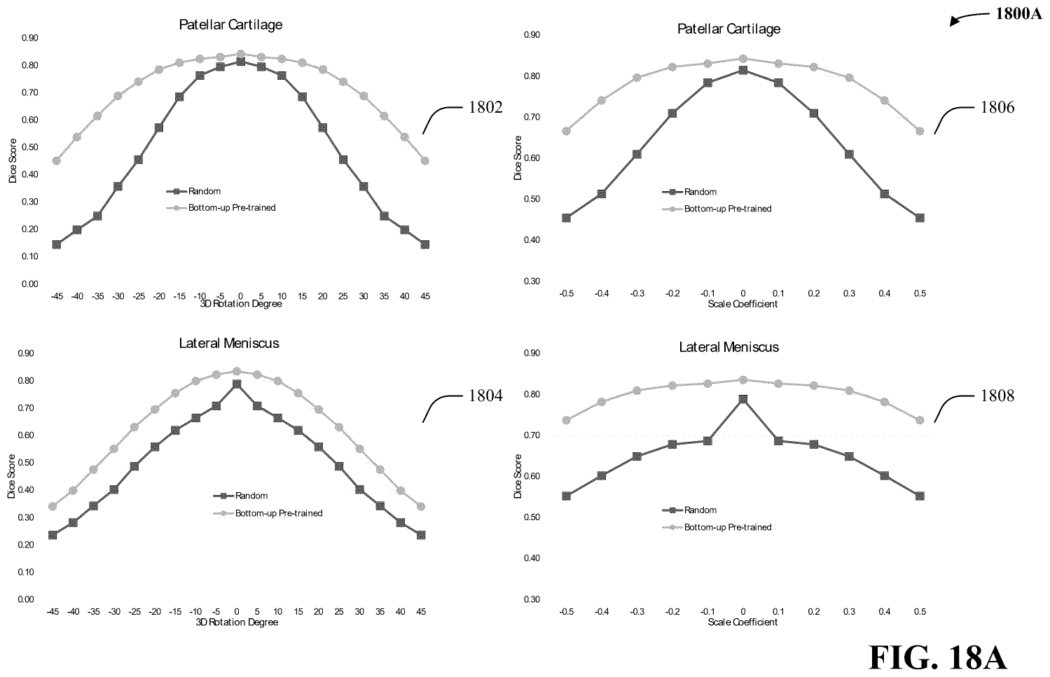

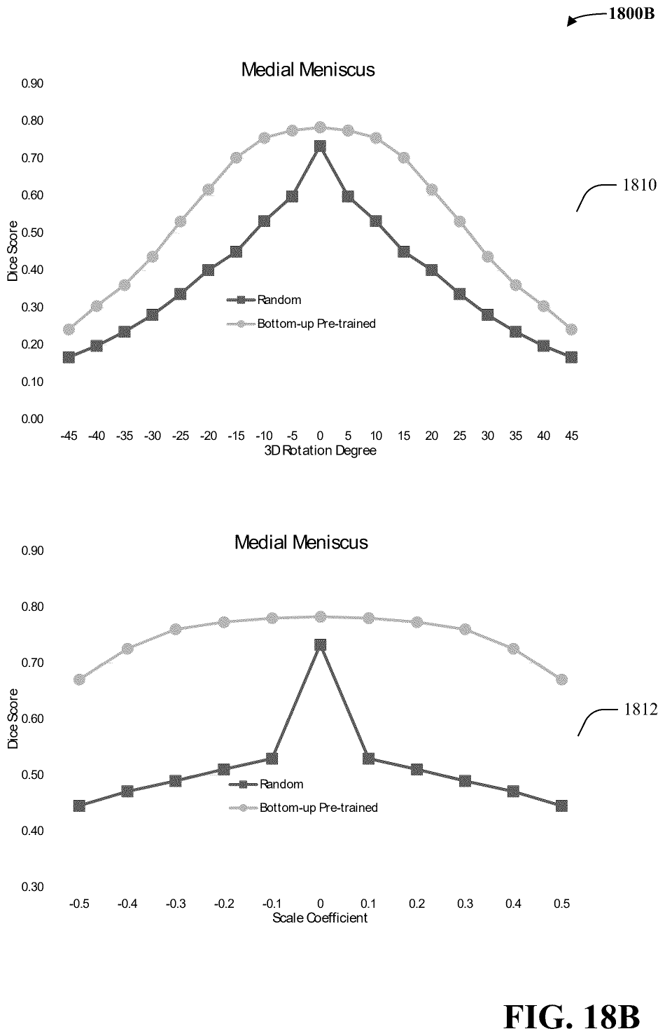

Model setup used for evaluation of model performance for a variety-driven approach is similar to the model setup described in FIG. 16, wherein the adaptation tasks comprise three adaptation tasks (e.g., 1708, 1710, 1712) of a new knee region. In various aspects, head and neck region tasks 1702 and pelvis region tasks 1704 can be utilized to create pre-trained weights 1706. The adaptation tasks comprise landmark 1708, landmark 1710, and landmark 1712 (e.g., patellar cartilage, lateral meniscus, and medial meniscus respectively). Additionally, three-dimensional rotation 1714 and three-dimensional scaling 1716 are applied to provide variety robustness before task adaptation and a full training dataset is utilized for task adaptation training. Evaluation results of applying variety robustness to a pre-trained foundation model on task adaptation are described with respect to FIGS. 18A and 18B.

FIGS. 18A and 18B illustrate example, non-limiting diagrams 800A and 800B of model performance for task adaptation with variety robustness in accordance with one or more embodiments described herein.

After adaptation to each of the adaptation tasks, the pre-trained foundation model with variety robustness is evaluated on a test dataset for a parameter space of the two data varieties (e.g., three-dimensional rotation 1714 and three-dimensional scaling 1716). Furthermore, model performance is evaluated for a bottom-up pre-trained weight and for randomly initialized weights.

As shown in FIGS. 18A and 18B (e.g., graph 1802, graph 1804, graph 1806, graph 1808, graph 1810, graph 1812), the bottom-up pre-trained weight exhibits improved variety robustness than the randomly initialized weights by inheriting data-variety robustness provided by bottom-up pre-training. For example, as illustrated in graph 1802, for an edge case that comprises a −45° three-dimensional rotation of the patellar cartilage, the bottom-up pre-trained weights outperforms the randomly initialized weights as it exhibits a significantly higher dice score, thereby indicating improved image segmenting of that landmark. Similar results are observed for both data varieties (e.g., 1714 and 1716) for each of the landmarks (e.g., 1708, 1710, 1712) of the adaptation tasks.

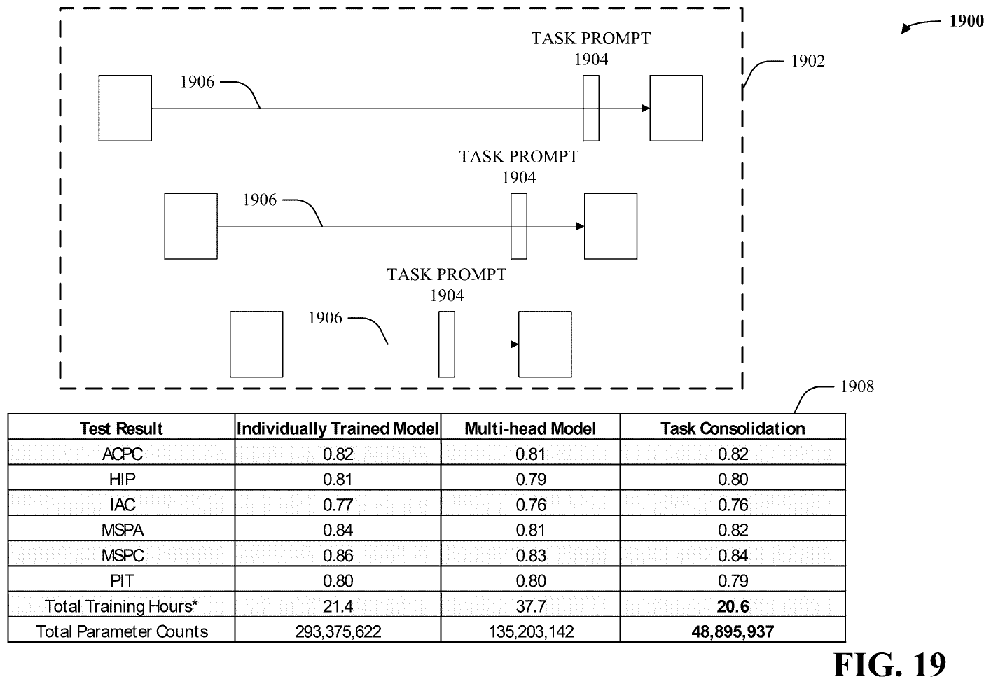

FIG. 19 illustrates an example, non-limiting diagram 1900 of model performance of task consolidation in accordance with one or more embodiments described herein.

Chart 1908 depicts model evaluation results for multi-task learning of task consolidation, a multi-head model, and individually trained models, where the three-dimensional MRI brain data is used for considering 6 multi-task learning landmarks, which include ACPC, HIP, IAC, MSPA, MSPC, and PIT. Task consolidation comprises using one model for multi-tasking, where tasks are controlled based on a task prompt (e.g., one shared encoder and one shared decoder where the tasks prompts control the tasks). Individually trained models comprises training a model for each task (e.g., training six models in this particular application). The multi-head model comprises using one model for multi-tasking, where tasks are controlled with different heads (e.g., one shared encoder with different heads or decoders for each task). Furthermore, task consolidation, in this particular application, utilizes a three-dimensional U-Net architecture (e.g., a convolutional neural network architecture designed for volumetric image segmentation, incorporating three-dimensional convolutional layers and skip connections to efficiently learn and preserve spatial information in imaging tasks), as depicted in 1902. The task prompt 1904 is considered as additional information during skip connections 1906. However, any suitable type of architecture can be utilized to implement task consolidation (e.g., attention-based network, convolution-based network).

Chart 1908 depicts dice scores of training each model for each of the 6 tasks based on each task's holdout dataset, as well as total training hours and total parameter counts. As shown in chart 1908, task consolidation achieves a significant decrease in training hours and total parameters compared to the multi-head model. Furthermore, as shown, task consolidation achieves multi-tasking performance comparable to the individually trained models while utilizing significantly less parameters than the individually trained models and multi-head model. For example, in this particular case where there are 6 tasks, the individually trained models will utilize six times the total number of parameters than task consolidation.

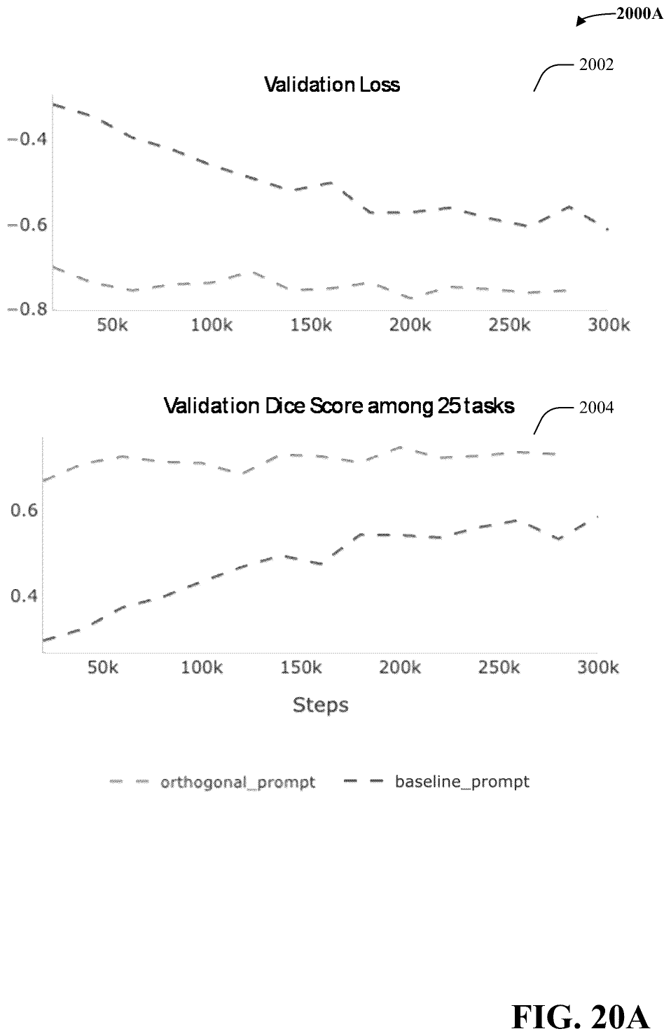

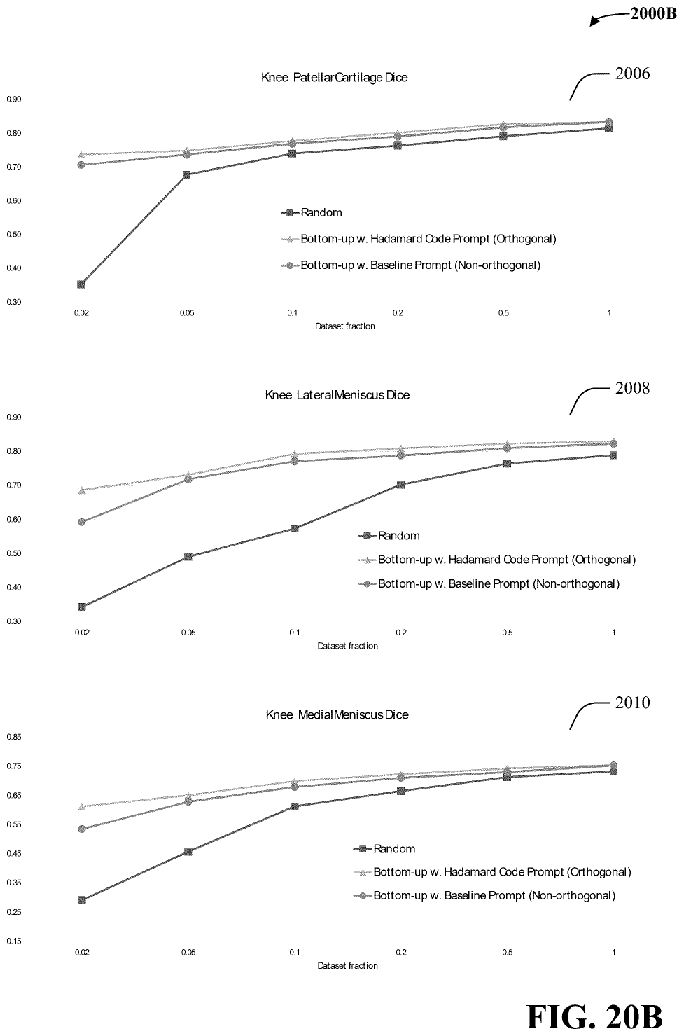

FIGS. 20A and 20B illustrate example, non-limiting diagrams 2000A and 2000B of model performance with orthogonal prompts in accordance with one or more embodiments described herein.

FIGS. 20A and 20B illustrate model performance of use of orthogonal prompts for pre-training and task adaptation. Model setup is similar to the model setup described in FIG. 15, wherein 25 tasks from the three-dimensional MROAR dataset are used to train region-based models. However, in this model setup, orthogonal Hadamard code prompts (e.g., Hadamard code for different tasks as prompt) are evaluated against non-orthogonal prompts (e.g., vector filled with task index as prompt). Evaluation is done in a multi-task learning setting to compare convergence speed and dice score progression during training, and in a few-shot learning setting to compare downstream adaptation in unseen tasks.

Graph 2002 and graph 2004 depict convergence trajectories between the orthogonal prompt and the non-orthogonal prompts. As shown, training with orthogonal prompts exhibits improved performance in convergence than the non-orthogonal prompts, even after 300k training steps. Further, after 300k training steps of the non-orthogonal prompts, the non-orthogonal prompts still do not exhibit convergence performance that exceeds or matches convergence performance of the orthogonal prompts before 300k training steps. Thus, orthogonal prompts in bottom-up task consolidation can offer significant convergence benefit in a multi-task pre-training setting, such that the model can reach better multi-task performance. Additionally, as illustrated in graphs of FIG. 20B (e.g., 2006, 2008, 2010), a bottom-up foundation model trained with orthogonal prompts displays an improved downstream adaptation property for different tasks and different data sizes.

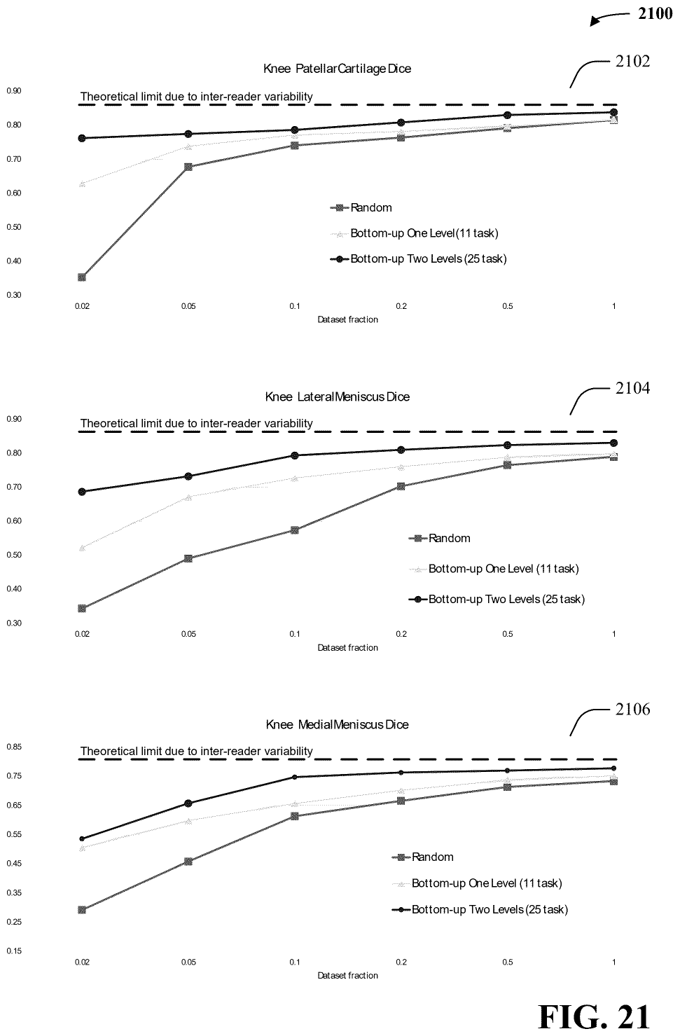

FIG. 21 illustrates an example, non-limiting diagram 2100 of model performance of emergence property in accordance with one or more embodiments described herein.

Graph 2102, graph 2104, and graph 2106 depict model performance of bottom-up foundation model emergence property for medical image segmenting. One bottom-up foundation model used is built by consolidating landmarks of a same region to form a region-based model, and the region-based model is consolidated with other region-based models to from a modality-based model (e.g., trained on 25 tasks). A second bottom-up foundation model used is built by only consolidating landmarks of a same region to form a region-based model (e.g., trained on 11 tasks). The bottom-up foundation models are evaluated on adaptation tasks in a few-shot learning setting, similar to the few-shot learning setting described in FIGS. 14 and 16.

As shown, the bottom-up process increases in scale for pre-training tasks, and performance improves significantly with minimal training data. This displays a controlled progression of emergence as the bottom-up process continues. Furthermore, as the number of bottom-up base tasks increases, performances for a full fine-tuning of the models are also observed to be improved towards their theoretical limit. This indicates that with bottom-up method, a generalized representation learned from other tasks can help the model perform beyond the capability of limited training data.

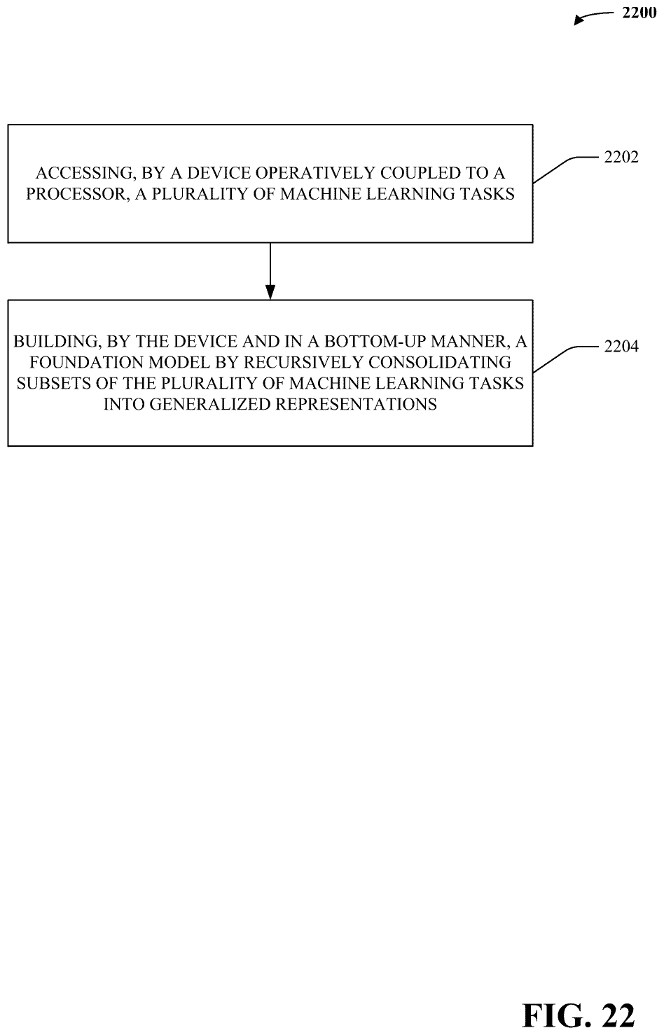

FIG. 22 illustrates a flow diagram of example, non-limiting computer-implemented methods 2200 that can facilitate building of foundation models via a bottom-up process in accordance with one or more embodiments described herein. In various cases, the bottom-up foundation model system 102 can facilitate the computer-implemented methods 2200.

In various instances, act 2202 can include accessing, by the device (e.g., via 110), a plurality of machine learning tasks (e.g., 104).

In various aspects, act 2204 can include building, by the device (e.g., via 112) and in a bottom-up manner, a foundation model by recursively consolidating subsets of the plurality of machine learning tasks into generalized representations.

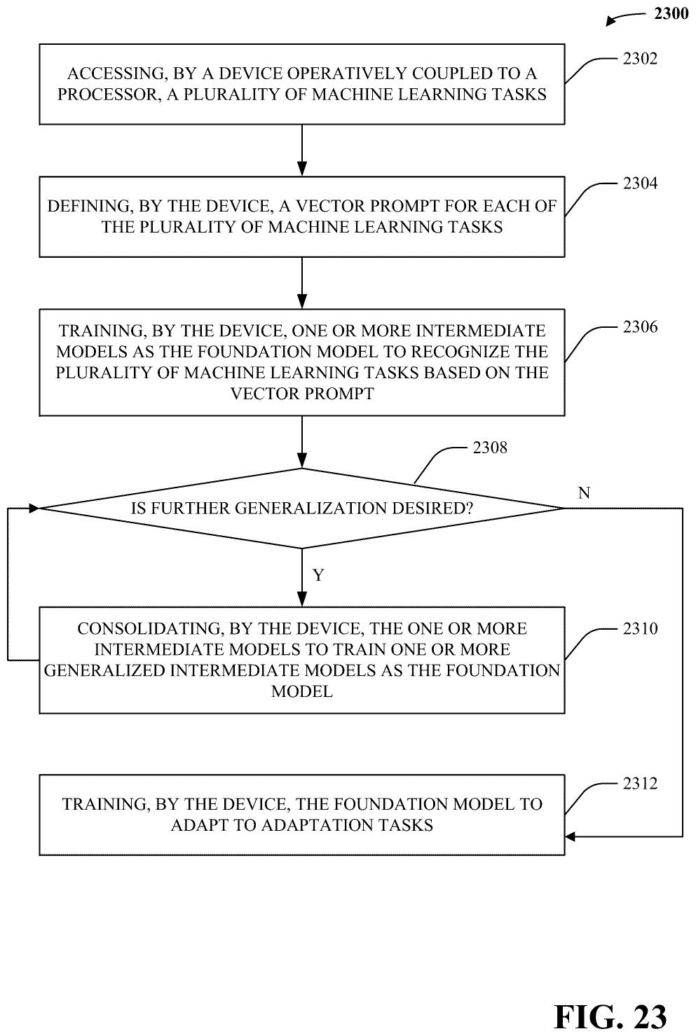

FIG. 23 illustrates a flow diagram of example, non-limiting computer-implemented methods 2300 that can facilitate building of foundation models via a bottom-up process in accordance with one or more embodiments described herein. In various cases, the bottom-up foundation model system 102 can facilitate the computer-implemented methods 2300.

In various instances, act 2302 can include accessing, by the device (e.g., via 110), a plurality of machine learning tasks (e.g., 104).

In various aspects, act 2304 can include defining, by the device (e.g., via 202), a vector prompt for each of the plurality of machine learning tasks.

Although not explicitly shown in FIG. 23, the vector prompts can be defined as orthogonal prompts to decouple task interference.

In various aspects, act 2306 can include training, by the device (e.g., via 902), one or more intermediate models as the foundation model to recognize the plurality of machine learning tasks based on the vector prompt.

In various aspects, act 2308 can include determining if further generalization is desired. If so (e.g., further generalization is desired), the computer-implemented methods 2300 can proceed to act 2310. If not (e.g., further generalization is not desired), the computer-implemented methods 2300 can proceed to act 2312.

In various aspects, act 2310 can include consolidating, by the device (e.g., via 112), the one or more intermediate models to train one or more generalized intermediate models as the foundation model. In various aspects, the one or more intermediate models can be recursively consolidated into more generalized models (e.g., the more generalized models are further consolidated into even more generalized models) until a desired level of generalization of the foundation model is achieved.

In various aspects, act 2312 can include training, by the device (e.g., via 902), the foundation model to adapt to adaptation tasks.

Various embodiments have been described herein with respect to building of bottom-up foundation models that contain technical information regarding medical image segmentation. However, these are mere non-limiting examples. In various cases, various embodiments described herein can be applied or extrapolated to build of bottom-up foundation models for any suitable domain, field, or application (e.g., are not limited just to building bottom-up foundation models for medical image segmentation).

Indeed, various embodiments can involve a computer program product for facilitating building of foundation models via a bottom-up process. In various aspects, the computer program product can comprise a non-transitory computer-readable memory (e.g., 108) having program instructions embodied therewith. In various instances, the program instructions can be executable by a processor (e.g., 106) to cause the processor to: access a plurality of machine learning tasks (e.g., 104); and build, in a bottom-up manner, a foundation model by recursively consolidating subsets of the plurality of machine learning tasks into generalized representations. In various aspects, the program instructions can be further executable to cause the processor to: consolidate two or more of the plurality of the machine learning tasks to train an intermediate model and consolidate two or more intermediate models to train a generalized intermediate model. In various instances, the program instructions can be further executable to cause the processor to: isolate one or more bottom-up processes based on characteristics of the bottom-up processes. In various aspects, the program instructions can be further executable to cause the processor to: define a vector prompt (e.g., 302) for each of the plurality of machine learning tasks and train the foundation model to recognize a machine learning task based on the vector prompt. In various aspects, the program instructions can be further executable to cause the processor to: define the vector prompts to be orthogonal to other vector prompts. In various cases, the program instructions can be further executable to cause the processor to: learn the generalized representations of the subsets of the plurality of machine learning tasks in their respective vector space in a decoupled manner. In various instances, the program instructions can be further executable to cause the processor to: adapt weight parameters based on the prompt vector to produce a corresponding output, and use the weight parameters as pre-trained weight parameters for adaptation tasks.

In various instances, machine learning algorithms or models can be implemented in any suitable way to facilitate any suitable aspects described herein. To facilitate some of the above-described machine learning aspects of various embodiments, consider the following discussion of artificial intelligence (AI). Various embodiments described herein can employ artificial intelligence to facilitate automating one or more features or functionalities. The components can employ various AI-based schemes for carrying out various embodiments/examples disclosed herein. In order to provide for or aid in the numerous determinations (e.g., determine, ascertain, infer, calculate, predict, prognose, estimate, derive, forecast, detect, compute) described herein, components described herein can examine the entirety or a subset of the data to which it is granted access and can provide for reasoning about or determine states of the system or environment from a set of observations as captured via events or data. Determinations can be employed to identify a specific context or action, or can generate a probability distribution over states, for example. The determinations can be probabilistic; that is, the computation of a probability distribution over states of interest based on a consideration of data and events. Determinations can also refer to techniques employed for composing higher-level events from a set of events or data.

Such determinations can result in the construction of new events or actions from a set of observed events or stored event data, whether or not the events are correlated in close temporal proximity, and whether the events and data come from one or several event and data sources. Components disclosed herein can employ various classification (explicitly trained (e.g., via training data) as well as implicitly trained (e.g., via observing behavior, preferences, historical information, receiving extrinsic information, and so on)) schemes or systems (e.g., support vector machines, neural networks, expert systems, Bayesian belief networks, fuzzy logic, data fusion engines, and so on) in connection with performing automatic or determined action in connection with the claimed subject matter. Thus, classification schemes or systems can be used to automatically learn and perform a number of functions, actions, or determinations.

A classifier can map an input attribute vector, z=(z₁, z₂, z₃, z₄, zₙ), to a confidence that the input belongs to a class, as by f(z)=confidence(class). Such classification can employ a probabilistic or statistical-based analysis (e.g., factoring into the analysis utilities and costs) to determinate an action to be automatically performed. A support vector machine (SVM) can be an example of a classifier that can be employed. The SVM operates by finding a hyper-surface in the space of possible inputs, where the hyper-surface attempts to split the triggering criteria from the non-triggering events. Intuitively, this makes the classification correct for testing data that is near, but not identical to training data. Other directed and undirected model classification approaches include, e.g., naïve Bayes, Bayesian networks, decision trees, neural networks, fuzzy logic models, or probabilistic classification models providing different patterns of independence, any of which can be employed. Classification as used herein also is inclusive of statistical regression that is utilized to develop models of priority.

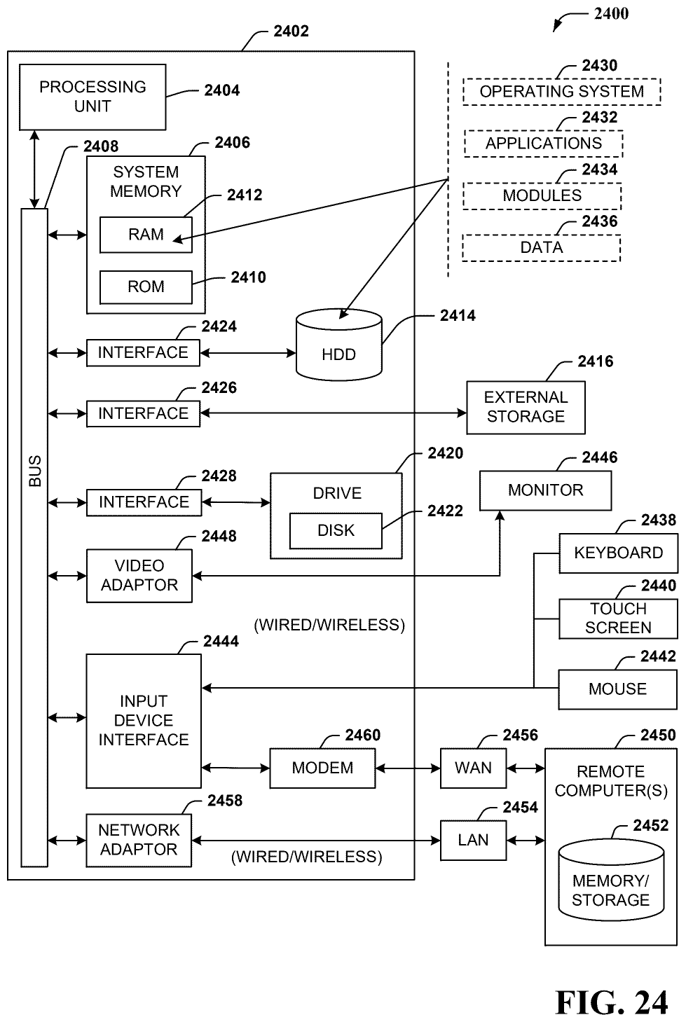

In order to provide additional context for various embodiments described herein, FIG. 24 and the following discussion are intended to provide a brief, general description of a suitable computing environment 2400 in which the various embodiments of the embodiment described herein can be implemented. While the embodiments have been described above in the general context of computer-executable instructions that can run on one or more computers, those skilled in the art will recognize that the embodiments can be also implemented in combination with other program modules or as a combination of hardware and software.

Generally, program modules include routines, programs, components, data structures, etc., that perform particular tasks or implement particular abstract data types. Moreover, those skilled in the art will appreciate that the inventive methods can be practiced with other computer system configurations, including single-processor or multi-processor computer systems, minicomputers, mainframe computers, Internet of Things (IoT) devices, distributed computing systems, as well as personal computers, hand-held computing devices, microprocessor-based or programmable consumer electronics, and the like, each of which can be operatively coupled to one or more associated devices.

The illustrated embodiments of the embodiments herein can be also practiced in distributed computing environments where certain tasks are performed by remote processing devices that are linked through a communications network. In a distributed computing environment, program modules can be located in both local and remote memory storage devices.

Computing devices typically include a variety of media, which can include computer-readable storage media, machine-readable storage media, or communications media, which two terms are used herein differently from one another as follows. Computer-readable storage media or machine-readable storage media can be any available storage media that can be accessed by the computer and includes both volatile and nonvolatile media, removable and non-removable media. By way of example, and not limitation, computer-readable storage media or machine-readable storage media can be implemented in connection with any method or technology for storage of information such as computer-readable or machine-readable instructions, program modules, structured data or unstructured data.

Computer-readable storage media can include, but are not limited to, random access memory (RAM), read only memory (ROM), electrically erasable programmable read only memory (EEPROM), flash memory or other memory technology, compact disk read only memory (CD-ROM), digital versatile disk (DVD), Blu-ray disc (BD) or other optical disk storage, magnetic cassettes, magnetic tape, magnetic disk storage or other magnetic storage devices, solid state drives or other solid state storage devices, or other tangible or non-transitory media which can be used to store desired information. In this regard, the terms “tangible” or “non-transitory” herein as applied to storage, memory or computer-readable media, are to be understood to exclude only propagating transitory signals per se as modifiers and do not relinquish rights to all standard storage, memory or computer-readable media that are not only propagating transitory signals per se.

Computer-readable storage media can be accessed by one or more local or remote computing devices, e.g., via access requests, queries or other data retrieval protocols, for a variety of operations with respect to the information stored by the medium.

Communications media typically embody computer-readable instructions, data structures, program modules or other structured or unstructured data in a data signal such as a modulated data signal, e.g., a carrier wave or other transport mechanism, and includes any information delivery or transport media. The term “modulated data signal” or signals refers to a signal that has one or more of its characteristics set or changed in such a manner as to encode information in one or more signals. By way of example, and not limitation, communication media include wired media, such as a wired network or direct-wired connection, and wireless media such as acoustic, RF, infrared and other wireless media.

With reference again to FIG. 24, the example environment 2400 for implementing various embodiments of the aspects described herein includes a computer 2402, the computer 2402 including a processing unit 2404, a system memory 2406 and a system bus 2408. The system bus 2408 couples system components including, but not limited to, the system memory 2406 to the processing unit 2404. The processing unit 2404 can be any of various commercially available processors. Dual microprocessors and other multi-processor architectures can also be employed as the processing unit 2404.

The system bus 2408 can be any of several types of bus structure that can further interconnect to a memory bus (with or without a memory controller), a peripheral bus, and a local bus using any of a variety of commercially available bus architectures. The system memory 2406 includes ROM 2410 and RAM 2412. A basic input/output system (BIOS) can be stored in a non-volatile memory such as ROM, erasable programmable read only memory (EPROM), EEPROM, which BIOS contains the basic routines that help to transfer information between elements within the computer 2402, such as during startup. The RAM 2412 can also include a high-speed RAM such as static RAM for caching data.

The computer 2402 further includes an internal hard disk drive (HDD) 2414 (e.g., EIDE, SATA), one or more external storage devices 2416 (e.g., a magnetic floppy disk drive (FDD) 2416, a memory stick or flash drive reader, a memory card reader, etc.) and a drive 2420, e.g., such as a solid state drive, an optical disk drive, which can read or write from a disk 2422, such as a CD-ROM disc, a DVD, a BD, etc. Alternatively, where a solid state drive is involved, disk 2422 would not be included, unless separate. While the internal HDD 2414 is illustrated as located within the computer 2402, the internal HDD 2414 can also be configured for external use in a suitable chassis (not shown). Additionally, while not shown in environment 2400, a solid state drive (SSD) could be used in addition to, or in place of, an HDD 2414. The HDD 2414, external storage device(s) 2416 and drive 2420 can be connected to the system bus 2408 by an HDD interface 2424, an external storage interface 2426 and a drive interface 2428, respectively. The interface 2424 for external drive implementations can include at least one or both of Universal Serial Bus (USB) and Institute of Electrical and Electronics Engineers (IEEE) 1394 interface technologies. Other external drive connection technologies are within contemplation of the embodiments described herein.

The drives and their associated computer-readable storage media provide nonvolatile storage of data, data structures, computer-executable instructions, and so forth. For the computer 2402, the drives and storage media accommodate the storage of any data in a suitable digital format. Although the description of computer-readable storage media above refers to respective types of storage devices, it should be appreciated by those skilled in the art that other types of storage media which are readable by a computer, whether presently existing or developed in the future, could also be used in the example operating environment, and further, that any such storage media can contain computer-executable instructions for performing the methods described herein.

A number of program modules can be stored in the drives and RAM 2412, including an operating system 2430, one or more application programs 2432, other program modules 2434 and program data 2436. All or portions of the operating system, applications, modules, or data can also be cached in the RAM 2412. The systems and methods described herein can be implemented utilizing various commercially available operating systems or combinations of operating systems.

Computer 2402 can optionally comprise emulation technologies. For example, a hypervisor (not shown) or other intermediary can emulate a hardware environment for operating system 2430, and the emulated hardware can optionally be different from the hardware illustrated in FIG. 24. In such an embodiment, operating system 2430 can comprise one virtual machine (VM) of multiple VMs hosted at computer 2402. Furthermore, operating system 2430 can provide runtime environments, such as the Java runtime environment or the .NET framework, for applications 2432. Runtime environments are consistent execution environments that allow applications 2432 to run on any operating system that includes the runtime environment. Similarly, operating system 2430 can support containers, and applications 2432 can be in the form of containers, which are lightweight, standalone, executable packages of software that include, e.g., code, runtime, system tools, system libraries and settings for an application.

Further, computer 2402 can be enable with a security module, such as a trusted processing module (TPM). For instance with a TPM, boot components hash next in time boot components, and wait for a match of results to secured values, before loading a next boot component. This process can take place at any layer in the code execution stack of computer 2402, e.g., applied at the application execution level or at the operating system (OS) kernel level, thereby enabling security at any level of code execution.

A user can enter commands and information into the computer 2402 through one or more wired/wireless input devices, e.g., a keyboard 2438, a touch screen 2440, and a pointing device, such as a mouse 2442. Other input devices (not shown) can include a microphone, an infrared (IR) remote control, a radio frequency (RF) remote control, or other remote control, a joystick, a virtual reality controller or virtual reality headset, a game pad, a stylus pen, an image input device, e.g., camera(s), a gesture sensor input device, a vision movement sensor input device, an emotion or facial detection device, a biometric input device, e.g., fingerprint or iris scanner, or the like. These and other input devices are often connected to the processing unit 2404 through an input device interface 2444 that can be coupled to the system bus 2408, but can be connected by other interfaces, such as a parallel port, an IEEE 1394 serial port, a game port, a USB port, an IR interface, a BLUETOOTH® interface, etc.

A monitor 2446 or other type of display device can be also connected to the system bus 2408 via an interface, such as a video adapter 2448. In addition to the monitor 2446, a computer typically includes other peripheral output devices (not shown), such as speakers, printers, etc.

The computer 2402 can operate in a networked environment using logical connections via wired or wireless communications to one or more remote computers, such as a remote computer(s) 2450. The remote computer(s) 2450 can be a workstation, a server computer, a router, a personal computer, portable computer, microprocessor-based entertainment appliance, a peer device or other common network node, and typically includes many or all of the elements described relative to the computer 2402, although, for purposes of brevity, only a memory/storage device 2452 is illustrated. The logical connections depicted include wired/wireless connectivity to a local area network (LAN) 2454 or larger networks, e.g., a wide area network (WAN) 2456. Such LAN and WAN networking environments are commonplace in offices and companies, and facilitate enterprise-wide computer networks, such as intranets, all of which can connect to a global communications network, e.g., the Internet.

When used in a LAN networking environment, the computer 2402 can be connected to the local network 2454 through a wired or wireless communication network interface or adapter 2458. The adapter 2458 can facilitate wired or wireless communication to the LAN 2454, which can also include a wireless access point (AP) disposed thereon for communicating with the adapter 2458 in a wireless mode.

When used in a WAN networking environment, the computer 2402 can include a modem 2460 or can be connected to a communications server on the WAN 2456 via other means for establishing communications over the WAN 2456, such as by way of the Internet. The modem 2460, which can be internal or external and a wired or wireless device, can be connected to the system bus 2408 via the input device interface 2444. In a networked environment, program modules depicted relative to the computer 2402 or portions thereof, can be stored in the remote memory/storage device 2452. It will be appreciated that the network connections shown are example and other means of establishing a communications link between the computers can be used.

When used in either a LAN or WAN networking environment, the computer 2402 can access cloud storage systems or other network-based storage systems in addition to, or in place of, external storage devices 2416 as described above, such as but not limited to a network virtual machine providing one or more aspects of storage or processing of information. Generally, a connection between the computer 2402 and a cloud storage system can be established over a LAN 2454 or WAN 2456 e.g., by the adapter 2458 or modem 2460, respectively. Upon connecting the computer 2402 to an associated cloud storage system, the external storage interface 2426 can, with the aid of the adapter 2458 or modem 2460, manage storage provided by the cloud storage system as it would other types of external storage. For instance, the external storage interface 2426 can be configured to provide access to cloud storage sources as if those sources were physically connected to the computer 2402.

The computer 2402 can be operable to communicate with any wireless devices or entities operatively disposed in wireless communication, e.g., a printer, scanner, desktop or portable computer, portable data assistant, communications satellite, any piece of equipment or location associated with a wirelessly detectable tag (e.g., a kiosk, news stand, store shelf, etc.), and telephone. This can include Wireless Fidelity (Wi-Fi) and BLUETOOTH® wireless technologies. Thus, the communication can be a predefined structure as with a conventional network or simply an ad hoc communication between at least two devices.

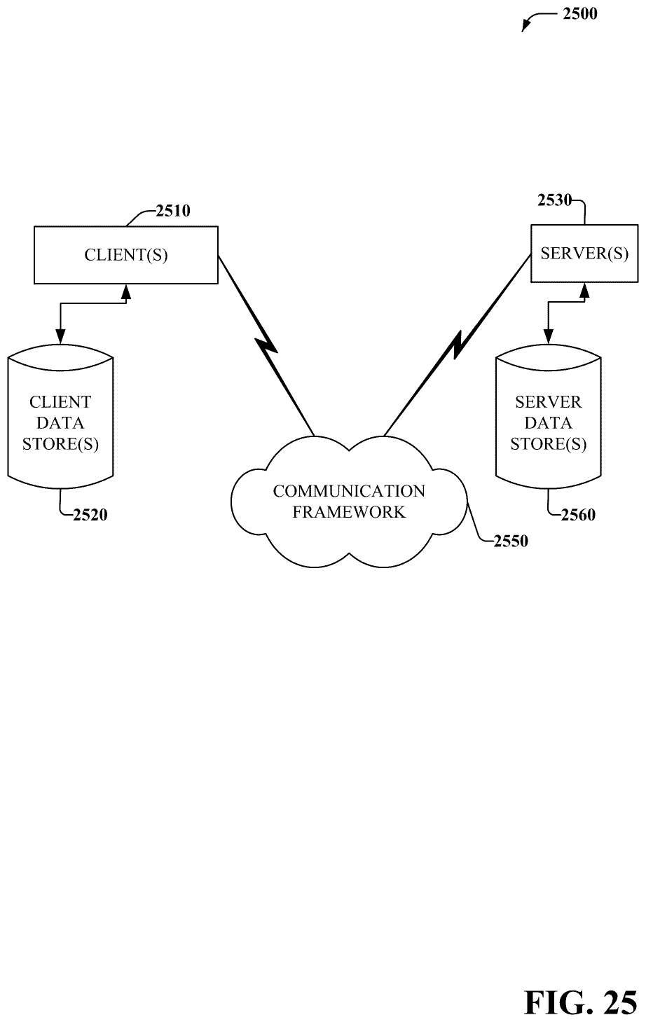

FIG. 25 is a schematic block diagram of a sample computing environment 2500 with which the disclosed subject matter can interact. The sample computing environment 2500 includes one or more client(s) 2510. The client(s) 2510 can be hardware or software (e.g., threads, processes, computing devices). The sample computing environment 2500 also includes one or more server(s) 2530. The server(s) 2530 can also be hardware or software (e.g., threads, processes, computing devices). The servers 2530 can house threads to perform transformations by employing one or more embodiments as described herein, for example. One possible communication between a client 2510 and a server 2530 can be in the form of a data packet adapted to be transmitted between two or more computer processes. The sample computing environment 2500 includes a communication framework 2550 that can be employed to facilitate communications between the client(s) 2510 and the server(s) 2530. The client(s) 2510 are operably connected to one or more client data store(s) 2520 that can be employed to store information local to the client(s) 2510. Similarly, the server(s) 2530 are operably connected to one or more server data store(s) 2540 that can be employed to store information local to the servers 2530.

Various embodiments may be a system, a method, an apparatus or a computer program product at any possible technical detail level of integration. The computer program product can include a computer readable storage medium (or media) having computer readable program instructions thereon for causing a processor to carry out aspects of various embodiments. The computer readable storage medium can be a tangible device that can retain and store instructions for use by an instruction execution device. The computer readable storage medium can be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium can also include the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network or a wireless network. The network can comprise copper transmission cables, optical transmission fibers, wireless transmission, routers, firewalls, switches, gateway computers or edge servers. A network adapter card or network interface in each computing/processing device receives computer readable program instructions from the network and forwards the computer readable program instructions for storage in a computer readable storage medium within the respective computing/processing device. Computer readable program instructions for carrying out operations of various embodiments can be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions can execute entirely on the user's computer, partly on the user's computer, as a stand-alone software package, partly on the user's computer and partly on a remote computer or entirely on the remote computer or server. In the latter scenario, the remote computer can be connected to the user's computer through any type of network, including a local area network (LAN) or a wide area network (WAN), or the connection can be made to an external computer (for example, through the Internet using an Internet Service Provider). In some embodiments, electronic circuitry including, for example, programmable logic circuitry, field-programmable gate arrays (FPGA), or programmable logic arrays (PLA) can execute the computer readable program instructions by utilizing state information of the computer readable program instructions to personalize the electronic circuitry, in order to perform various aspects.

Various aspects are described herein with reference to flowchart illustrations or block diagrams of methods, apparatus (systems), and computer program products according to various embodiments. It will be understood that each block of the flowchart illustrations or block diagrams, and combinations of blocks in the flowchart illustrations or block diagrams, can be implemented by computer readable program instructions. These computer readable program instructions can be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart or block diagram block or blocks. These computer readable program instructions can also be stored in a computer readable storage medium that can direct a computer, a programmable data processing apparatus, or other devices to function in a particular manner, such that the computer readable storage medium having instructions stored therein comprises an article of manufacture including instructions which implement aspects of the function/act specified in the flowchart or block diagram block or blocks. The computer readable program instructions can also be loaded onto a computer, other programmable data processing apparatus, or other device to cause a series of operational acts to be performed on the computer, other programmable apparatus or other device to produce a computer implemented process, such that the instructions which execute on the computer, other programmable apparatus, or other device implement the functions/acts specified in the flowchart or block diagram block or blocks.

The flowcharts and block diagrams in the Figures illustrate the architecture, functionality, and operation of possible implementations of systems, methods, and computer program products according to various embodiments. In this regard, each block in the flowchart or block diagrams can represent a module, segment, or portion of instructions, which comprises one or more executable instructions for implementing the specified logical function(s). In some alternative implementations, the functions noted in the blocks can occur out of the order noted in the Figures. For example, two blocks shown in succession can, in fact, be executed substantially concurrently, or the blocks can sometimes be executed in the reverse order, depending upon the functionality involved. It will also be noted that each block of the block diagrams or flowchart illustration, and combinations of blocks in the block diagrams or flowchart illustration, can be implemented by special purpose hardware-based systems that perform the specified functions or acts or carry out combinations of special purpose hardware and computer instructions.

While the subject matter has been described above in the general context of computer-executable instructions of a computer program product that runs on a computer or computers, those skilled in the art will recognize that this disclosure also can or can be implemented in combination with other program modules. Generally, program modules include routines, programs, components, data structures, etc. that perform particular tasks or implement particular abstract data types. Moreover, those skilled in the art will appreciate that various aspects can be practiced with other computer system configurations, including single-processor or multiprocessor computer systems, mini-computing devices, mainframe computers, as well as computers, hand-held computing devices (e.g., PDA, phone), microprocessor-based or programmable consumer or industrial electronics, and the like. The illustrated aspects can also be practiced in distributed computing environments in which tasks are performed by remote processing devices that are linked through a communications network. However, some, if not all aspects of this disclosure can be practiced on stand-alone computers. In a distributed computing environment, program modules can be located in both local and remote memory storage devices.

As used in this application, the terms “component,” “system,” “platform,” “interface,” and the like, can refer to or can include a computer-related entity or an entity related to an operational machine with one or more specific functionalities. The entities disclosed herein can be either hardware, a combination of hardware and software, software, or software in execution. For example, a component can be, but is not limited to being, a process running on a processor, a processor, an object, an executable, a thread of execution, a program, or a computer. By way of illustration, both an application running on a server and the server can be a component. One or more components can reside within a process or thread of execution and a component can be localized on one computer or distributed between two or more computers. In another example, respective components can execute from various computer readable media having various data structures stored thereon. The components can communicate via local or remote processes such as in accordance with a signal having one or more data packets (e.g., data from one component interacting with another component in a local system, distributed system, or across a network such as the Internet with other systems via the signal). As another example, a component can be an apparatus with specific functionality provided by mechanical parts operated by electric or electronic circuitry, which is operated by a software or firmware application executed by a processor. In such a case, the processor can be internal or external to the apparatus and can execute at least a part of the software or firmware application. As yet another example, a component can be an apparatus that provides specific functionality through electronic components without mechanical parts, wherein the electronic components can include a processor or other means to execute software or firmware that confers at least in part the functionality of the electronic components. In an aspect, a component can emulate an electronic component via a virtual machine, e.g., within a cloud computing system.

In addition, the term “or” is intended to mean an inclusive “or” rather than an exclusive “or.” That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. As used herein, the term “and/or” is intended to have the same meaning as “or.” Moreover, articles “a” and “an” as used in the subject specification and annexed drawings should generally be construed to mean “one or more” unless specified otherwise or clear from context to be directed to a singular form. As used herein, the terms “example” or “exemplary” are utilized to mean serving as an example, instance, or illustration. For the avoidance of doubt, the subject matter disclosed herein is not limited by such examples. In addition, any aspect or design described herein as an “example” or “exemplary” is not necessarily to be construed as preferred or advantageous over other aspects or designs, nor is it meant to preclude equivalent exemplary structures and techniques known to those of ordinary skill in the art.

The herein disclosure describes non-limiting examples. For case of description or explanation, various portions of the herein disclosure utilize the term “each,” “every,” or “all” when discussing various examples. Such usages of the term “each,” “every,” or “all” are non-limiting. In other words, when the herein disclosure provides a description that is applied to “each,” “every,” or “all” of some particular object or component, it should be understood that this is a non-limiting example, and it should be further understood that, in various other examples, it can be the case that such description applies to fewer than “each,” “every,” or “all” of that particular object or component.

As it is employed in the subject specification, the term “processor” can refer to substantially any computing processing unit or device comprising, but not limited to, single-core processors; single-processors with software multithread execution capability; multi-core processors; multi-core processors with software multithread execution capability; multi-core processors with hardware multithread technology; parallel platforms; and parallel platforms with distributed shared memory. Additionally, a processor can refer to an integrated circuit, an application specific integrated circuit (ASIC), a digital signal processor (DSP), a field programmable gate array (FPGA), a programmable logic controller (PLC), a complex programmable logic device (CPLD), a discrete gate or transistor logic, discrete hardware components, or any combination thereof designed to perform the functions described herein. Further, processors can exploit nano-scale architectures such as, but not limited to, molecular and quantum-dot based transistors, switches and gates, in order to optimize space usage or enhance performance of user equipment. A processor can also be implemented as a combination of computing processing units. In this disclosure, terms such as “store,” “storage,” “data store,” data storage,” “database,” and substantially any other information storage component relevant to operation and functionality of a component are utilized to refer to “memory components,” entities embodied in a “memory,” or components comprising a memory. It is to be appreciated that memory or memory components described herein can be either volatile memory or nonvolatile memory, or can include both volatile and nonvolatile memory. By way of illustration, and not limitation, nonvolatile memory can include read only memory (ROM), programmable ROM (PROM), electrically programmable ROM (EPROM), electrically erasable ROM (EEPROM), flash memory, or nonvolatile random access memory (RAM) (e.g., ferroelectric RAM (FeRAM). Volatile memory can include RAM, which can act as external cache memory, for example. By way of illustration and not limitation, RAM is available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), direct Rambus RAM (DRRAM), direct Rambus dynamic RAM (DRDRAM), and Rambus dynamic RAM (RDRAM). Additionally, the disclosed memory components of systems or computer-implemented methods herein are intended to include, without being limited to including, these and any other suitable types of memory.

What has been described above include mere examples of systems and computer-implemented methods. It is, of course, not possible to describe every conceivable combination of components or computer-implemented methods for purposes of describing this disclosure, but many further combinations and permutations of this disclosure are possible. Furthermore, to the extent that the terms “includes,” “has,” “possesses,” and the like are used in the detailed description, claims, appendices and drawings such terms are intended to be inclusive in a manner similar to the term “comprising” as “comprising” is interpreted when employed as a transitional word in a claim.

The descriptions of the various embodiments have been presented for purposes of illustration, but are not intended to be exhaustive or limited to the embodiments disclosed. Many modifications and variations will be apparent without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A system, comprising:
a processor that executes computer-executable components stored in a non-transitory computer-readable memory, the computer-executable components comprising:
an access component that accesses a plurality of machine learning tasks; and
a model component that builds, in a bottom-up manner, a foundation model by recursively consolidating subsets of the plurality of machine learning tasks into generalized representations.

2. The system of claim 1, wherein the computer-executable components further comprise:
a training component that consolidates two or more of the plurality of machine learning tasks to train an intermediate model, and wherein the training component consolidates two or more intermediate models to train a generalized intermediate model.

3. The system of claim 1, wherein the computer-executable components further comprise:
a grouping component that isolates one or more bottom-up processes based on characteristics of the one or more bottom-up processes.

4. The system of claim 1, wherein the computer-executable components further comprise:
an assignment component that defines a vector prompt for each of the plurality of machine learning tasks, and wherein the training component trains the foundation model to recognize a machine learning task based on the vector prompt.

5. The system of claim 4, wherein the training component trains the foundation model to adapt weight parameters based on the prompt vector to produce a corresponding output, and wherein the training component uses the weight parameters as pre-trained weight parameters for adaptation tasks.

6. The system of claim 4, wherein the assignment component defines vector prompts to be orthogonal to other vector prompts.

7. The system of claim 6, wherein the training component learns the generalized representations of the subsets of the plurality of machine learning tasks in their respective vector space in a decoupled manner.

8. The system of claim 1, wherein the foundation model is trained for computer vision machine learning tasks or text processing machine learning tasks.

9. A computer-implemented method, comprising:
accessing, by a device operatively coupled to a processor, a plurality of machine learning tasks; and
building, by the device and in a bottom-up manner, a foundation model by recursively consolidating subsets of the plurality of machine learning tasks into generalized representations.

10. The computer-implemented method of claim 9, further comprising:
consolidating, by the device, two or more of the plurality of machine learning tasks to train an intermediate model; and
consolidating, by the device, two or more intermediate models to train a generalized intermediate model.

11. The computer-implemented method of claim 9, further comprising:
isolating, by the device, one or more bottom-up processes based on characteristics of the one or more bottom-up processes.

12. The computer-implemented method of claim 9, further comprising:
defining, by the device, a vector prompt for each of the plurality of machine learning tasks; and
training, by the device, the foundation model to recognize a machine learning task based on the vector prompt.

13. The computer-implemented method of claim 12, further comprising:
training, by the device, the foundation model to adapt weight parameters based on the prompt vector to product a corresponding output; and
utilizing, by the device, the weight parameters as pre-trained weight parameters for adaptation tasks.

14. The computer-implemented method of claim 12, further comprising:
defining, by the device, vector prompts to be orthogonal to other vector prompts.

15. The computer-implemented method of claim 14, further comprising:
learning, by the device, the generalized representations of the subsets of the plurality of machine learning tasks in their respective vector space in a decoupled manner.

16. A computer program product for facilitating bottom-up foundation models for medical device applications, the computer program product comprising a non-transitory computer-readable memory having program instructions embodied therewith, the program instructions executable by a processor to cause the processor to:
access a plurality of machine learning tasks; and
build, in a bottom-up manner, a foundation model by recursively consolidating subsets of the plurality of machine learning tasks into generalized representations.

17. The computer program product of claim 16, wherein the processor consolidates two or more of the plurality of machine learning tasks to train an intermediate model, and wherein the processor consolidates two or more intermediate models to train a generalized intermediate model.

18. The computer program product of claim 16, wherein the processor isolates one or more bottom-up processes based on characteristics of the one or more bottom-up processes.

19. The computer program product of claim 16, wherein the processor defines a vector prompt for each of the plurality of machine learning tasks, and wherein the processor trains the foundation model to recognize a machine learning task based on the vector prompt.

20. The computer program product of claim 19, wherein the processor trains the foundation model to adapt weight parameters based on the prompt vector to product a corresponding output, and wherein the processor utilizes the weight parameters as pre-trained weight parameters for adaptation tasks.
